(19) United States
(12) Patent Application Publication
(10) Pub. No.: US 2017/0250620 A1
(43) Pub. Date: Aug. 31, 2017

(54) AVERAGE CURRENT MODULATOR FOR AN LED DRIVER

(71) Applicant: QUEEN'S UNIVERSITY AT KINGSTON, KINGSTON (CA)

(72) Inventors: BRIAN J.R. WHITE, ANDOVER, MA (US); YAN-FEI LIU, KINGSTON (CA)

(21) Appl. No.: 15/518,022

(22) PCT Filed: Oct. 8, 2015
(86) PCT No.: PCT/CA2015/051017

§ 371 Date: Apr. 10, 2017

Related U.S. Application Data
(60) Provisional application No. 62/061,464, filed on Oct. 8, 2014.

(51) Int. Cl. H02M 7/06; H02M 1/42; H02M 1/08; H02M 1/12; H05B 33/08; H02M 3/335; H02M 1/14

(52) U.S. Cl. CPC H02M 7/06; H02M 3/33507; H02M 1/42; H02M 1/14; H02M 1/12; H05B 33/0815; H02M 1/08; H02M 2001/0048

(57) ABSTRACT

The invention relates to circuits and methods that that reduce or eliminate the second harmonic ripple in the output of a single stage AC-DC converter, while minimizing the required output capacitance. The circuits and methods include an average current modulator having a switch connected in series with the DC load, and strategies for sampling the load current and controlling a duty cycle of the switch by comparing the sampled current to a current control signal so that the average load current is maintained at a selected current, and the second harmonic ripple component of the load current is reduced or eliminated. The circuits and methods substantially improve the performance and reliability of single stage AC-DC converters. The circuits and methods are particularly useful in applications were low ripple and high reliability are desirable, such as in driving LED loads in lighting applications.

### RELATED APPLICATION

This application claims the benefit of the filing date of U.S. Patent Application No. 62/061,464, filed on 9 Oct. 2014, the contents of which are incorporated herein by reference in their entirety.

### FIELD

The invention relates to circuits and methods that that eliminate the second harmonic ripple in the output of a single stage AC-DC converter, while minimizing the required output capacitance. The circuits and methods substantially improve the performance and reliability of single stage AC-DC converters. The circuits and methods are particularly useful in applications were low ripple and high reliability are desirable, such as in driving LED loads in lighting applications.

### BACKGROUND

Solid state lighting offers numerous benefits that will soon see it overtake fluorescent lighting as the dominant source of residential and commercial lighting. Light emitting diode (LED) lamps offer higher luminous efficiency, longer lifetimes (50,000+hours), and contain no hazardous materials (such as mercury). These benefits reduce the cost and the environmental impact of lighting.

Residential and commercial lighting powered directly by the main (utility) power grid must meet certain requirements set by government agencies. High power factor (PF) is desirable to maximize the power transferred over the grid, decrease noise, and ensure stability. Energy Star regulations (Standard: Energy Star Qualifying Criteria for Solid Stage Lighting (SSL) Luminaires, Version 1.3, U.S. Environmental Protection Agency and U.S. Department of Energy, 2010) require that residential lighting achieves 0.7 PF and requires commercial lighting achieve 0.9 PF. Two stage LED drivers (e.g., FIG. 1A) have commonly been used to provide this high performance. These drivers consist of a high performing AC-DC power factor correction (PFC) circuit, followed by a DC-DC converter which provides a constant current to an LED lamp. This configuration requires relatively low energy storage capacitance in the PFC stage, as the DC-DC converter is able to follow a fluctuating input voltage while still providing a constant output current. However, the two stage approach suffers from a high component count which leads to high power loss and high component cost.

To reduce the component count, single stage PFC converters can be employed to power LED lamps (e.g., FIG. 1B). Single stage PFC LED drivers maintain a high power factor while regulating the LED current. Though a high power factor can be achieved by a single stage AC-DC topology, it results in an energy imbalance between the AC input and the DC output. This energy imbalance requires energy storage capacitors to store energy during the zero crossings of the input voltage to maintain a smooth output. If these capacitors are not large enough, the output will contain significant ripple at twice the line frequency. This results in a flicker in the light output at twice the line frequency, which is undesirable and may be harmful to humans. Conventionally, single stage PFC LED drivers utilize very large electrolytic capacitors to limit the current ripple within the LED load, and reduce the ripple in the light produced by the LEDs. Electrolytic capacitors have significantly lower lifespans (˜10,000 hours) than LED chips, and the use of these capacitors in LED drivers limits the overall life of the resulting LED lamp. It is therefore desirable to use an LED driver that does not require a large capacitor to provide a low output current ripple.

Various LED driving techniques have been proposed to reduce the required energy storage capacitance, thus avoiding electrolytic capacitors. However, the prior approaches suffer from drawbacks such as high component count and cost, significant LED current ripple, low power factor, and/or high conversion losses leading to low efficiency.

### SUMMARY

Described herein are circuits and methods for an AC-DC converter for driving a DC load such as an LED. Embodiments include an average current modulator that provides a controlled average current output, such that low frequency content (i.e., ripple at the 2^{nd} harmonic of the AC line frequency) is substantially removed from the output. Embodiments work with AC-DC control circuits to provide a high power factor LED driver, and do not require large energy storage capacitors, enabling use of long life film or ceramic capacitors.

Embodiments minimize stress applied to the LED load, while ensuring the desired average current is not interrupted. This prevents the need for specific PFC stage designs for each unique LED load, and instead allows any choice of LED load to be used with a conventional PFC converter in conjunction with the average current modulator.

One embodiment provides direct PFC output voltage adjustment, and is paired with an output voltage controlled PFC converter and has a programmed LED current reference. The average current modulator dictates the duty cycle of a modulating switch Q_{MOD} such that the average value of LED current is maintained as the programmed current. The peak of the varying duty cycle is detected, and is used to adjust the average value of the PFC output voltage by sending a control signal to the PFC controller. The voltage is adjusted so that the peak duty cycle is very high (e.g., 90% or higher), and the LED current stress is minimal.

Other embodiments are based on an output current controlled PFC converter, and eliminate the need to send a control signal to the PFC converter. According to such embodiments, the average LED current level is dictated by the current programmed by the PFC controller, and the average current modulation circuit generates a current reference to control the switching of Q_{MOD}.

For example, one embodiment sets the peak duty cycle to, for example, 85%, 90%, or 95%, and samples the average LED current that is achieved using this duty cycle at the minimum PFC output voltage value (V_{OUT}_{_}ₘᵢₙ). This sampled value is used as the current reference of the average current modulator to control Q_{MOD}.

Another embodiment is based on an approach similar to the direct PFC output voltage adjustment control, except that the peak duty cycle is used to generate the current reference for the average current modulator. In this way, the current reference is set such that a high duty cycle is utilized at the PFC output voltage minimum value (V_{OUT}_{_}ₘᵢₙ), limiting the magnitude of the LED current pulses at the PFC output voltage maximum (V_{OUT}_{_}ₘₐₓ).

Another embodiment filters a rectifier diode current to obtain the low frequency average value and uses this as the current reference for the average current modulator. The diode's average current is equal to the output current programmed by the PFC converter.

All embodiments ensure that the minimum voltage applied to the LED load (V_{OUT}_{_}ₘᵢₙ) is sufficient to provide a large enough current pulse to obtain the desired average current, while not causing excessively high current pulses that would damage the LED devices when the PFC output voltage is at its maximum value (V_{OUT}_{_}ₘₐₓ). While the maximum current pulse is dictated by the maximum PFC output voltage, the capacitance used in the PFC stage dictates how far this maximum value is from the minimum value. More detailed description of these embodiments is provided below.

One embodiment provides an AC-DC converter, comprising; a power factor correction (PFC) stage that receives AC power and outputs DC load current, the DC load current comprising a low-frequency AC ripple component; a series-connected switch and current sensing resistor, the series-connected switch and current sensing resistor connected in series with the load; an average current controller that samples the load current and controls a duty cycle of the switch so that the average load current is maintained at a selected current by comparing to a current control signal; wherein the low-frequency AC ripple component of the load current is reduced or eliminated.

The average current controller controls the duty cycle of the switch at a high modulation frequency. The high modulation frequency may be between 20 kHz and 25 kHz.

In one embodiment, the current control signal is a programmed reference value.

In one embodiment, the average current controller comprises an integrator and a sample and hold circuit to sample the load current. In another embodiment, the average current controller comprises an integrator and a low pass filter to sample the load current.

The AC-DC converter may comprise a peak duty cycle controller that generates an error signal by comparing a detected peak duty cycle to a programmed peak duty cycle of the switch; wherein the error signal adjusts average output voltage of the PFC stage such that the peak duty cycle of the switch is equal to the programmed peak duty cycle.

In another embodiment, the AC-DC converter comprises a peak duty cycle controller that generates an error signal by comparing a detected peak duty cycle to a programmed peak duty cycle of the switch; wherein the current control signal is set according to the error signal.

The peak duty cycle controller may include a sample and hold circuit. The peak duty cycle controller may include a forward, low impedance current path and a reverse, high impedance current path.

The AC-DC converter may further comprise a load current limiting loop that limits the load current by adjusting a gate drive voltage of the switch.

Also described herein is a method for reducing or eliminating a low-frequency AC ripple component of a load current of a single-stage PFC AC-DC converter, comprising sampling the load current and comparing the sampled load current to a current control signal corresponding to a selected current; controlling a duty cycle of a switch connected in series with the load so that an average load current is maintained at the selected current; wherein the low-frequency AC ripple component of the load current is reduced or eliminated.

The method may comprise controlling the duty cycle of the switch at a high modulation frequency. The high modulation frequency may be between 20 kHz and 25 kHz. The method may comprise using a current control signal that is a programmed reference value. The method may comprise sampling the load current using an integrator and a sample and hold circuit. The method may comprise sampling the load current using an integrator and a low pass filter. The method may comprise limiting the load current by adjusting a gate drive voltage of the switch.

In one embodiment the method comprises detecting a peak duty cycle of the switch; generating an error signal by comparing the detected peak duty cycle of the switch to a programmed peak duty cycle; and using the error signal to adjust average output voltage of the PFC stage such that the peak duty cycle of the switch is equal to the programmed peak duty cycle.

In another embodiment the method comprises detecting a peak duty cycle of the switch; generating an error signal by comparing the detected peak duty cycle of the switch to a programmed peak duty cycle; and setting the current control signal according to the error signal.

Detecting a peak duty cycle of the switch may comprise using a sample and hold circuit. Detecting a peak duty cycle of the switch may comprise using a forward, low impedance current path and a reverse, high impedance current path.

Also described herein are circuits and methods for use with an AC-DC converter. The circuits and methods may be applied to an existing AC-DC converter, e.g., as an add-on, to improve the performance and reliability of the AC-DC converter. Such a circuit may comprise a series-connected switch and current sensing resistor, wherein the series-connected switch and current sensing resistor are to be connected in series with the load of the AC-DC converter; and an average current controller that samples the load current and controls a duty cycle of the switch so that the average load current is maintained at a selected current by comparing to a current control signal; wherein a low-frequency AC ripple component of the load current is reduced or eliminated. The circuits and methods may further comprise using a peak duty cycle controller. The average current controller and the peak duty cycle controller of such embodiments may include features as described herein.

### BRIEF DESCRIPTION OF THE DRAWINGS

For a better understanding of the invention, and to show more clearly how it may be carried into effect, embodiments will be described, by way of example, with reference to the accompanying drawings, wherein:

FIGS. 1A and 1B are block diagrams of conventional two stage and single stage LED driver configurations, respectively.

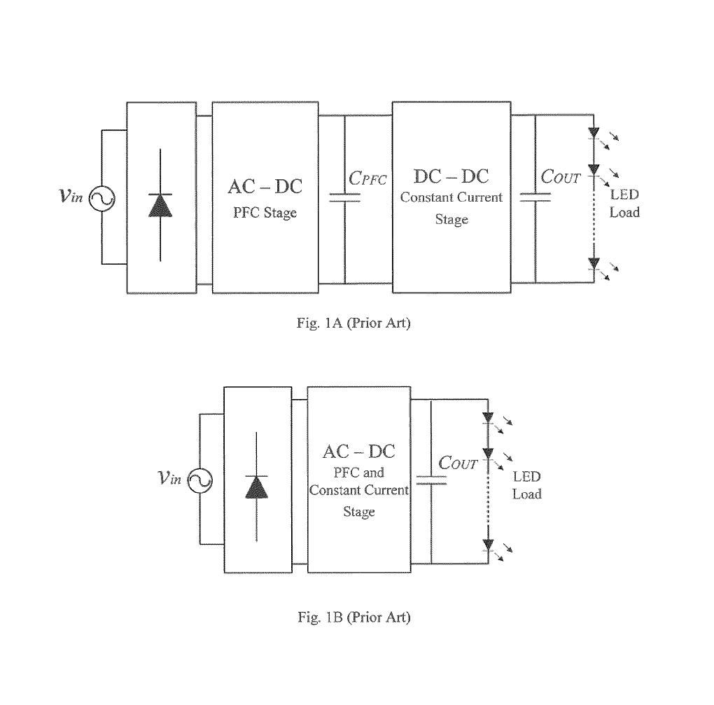

FIG. 2 is a block diagram of an average current modulator implemented in a single stage PFC converter, according to one embodiment.

FIG. 3 shows operational waveforms of an average current modulator, according to one embodiment.

FIG. 4A is a block diagram of a controller for an average current modulator, according to one embodiment.

FIG. 4B is a block diagram of a controller for an average current modulator, according to one embodiment.

FIG. 4C is a block diagram of an average current modulator, according to one embodiment.

FIG. 5 is an equivalent circuit diagram of an LED.

FIG. 6 is a block diagram of a peak duty cycle controller with output voltage adjustment, according to one embodiment.

FIG. 7 is a block diagram of a peak duty cycle controller with output voltage adjustment and simplified peak detector, according to one embodiment.

FIG. 8 is a block diagram of a peak duty cycle controller with average current adjustment, according to one embodiment.

FIG. 9 is a block diagram of a peak duty cycle controller with average current adjustment and simplified peak detector, according to one embodiment.

FIG. 10 is a block diagram of an average current modulator and peak duty cycle controller, according to one embodiment.

FIG. 11A is a circuit diagram of a conventional MOSFET gate driver.

FIGS. 11B and 11C are circuit diagrams of MOSFET gate drivers according to embodiments that limit the load current of an LED driver.

FIG. 12 is a circuit diagram of a buck-boost LED driver with output voltage adjustment, according to an embodiment described in Example 1.

FIGS. 13 and 14 are plots showing measured LED current and light output of a conventional buck-boost driver as described in Example 1.

FIG. 15 is a plot showing measured output voltage ripple and LED current of a buck-boost average current modulator embodiment as described in Example 1.

FIGS. 16 and 17 are plots showing measured LED current at peak duty cycle and minimum duty cycle, respectively, of a buck-boost average current modulator embodiment as described in Example 1.

FIG. 18 is a plot showing measured output voltage ripple and LED light of a buck-boost average current modulator embodiment as described in Example 1.

FIGS. 19 and 20 are plots showing measured LED light at peak duty cycle and minimum duty cycle, respectively, of a buck-boost average current modulator embodiment as described in Example 1.

FIG. 21 is a circuit diagram of a flyback LED driver with average current adjustment, according to an embodiment described in Example 2.

FIGS. 22 and 23 are plots showing measured LED current and light output of a conventional flyback driver as described in Example 2.

FIG. 24 is a plot showing measured output voltage ripple and LED current of a flyback average current modulator embodiment as described in Example 2.

FIGS. 25 and 26 are plots showing measured LED current at peak duty cycle and minimum duty cycle, respectively, of a flyback average current modulator embodiment as described in Example 2.

FIG. 27 is a plot showing measured output voltage ripple and LED light of a flyback average current modulator embodiment as described in Example 2.

FIGS. 28 and 29 are plots showing measured LED light at peak duty cycle and minimum duty cycle, respectively, of a flyback average current modulator embodiment as described in Example 2.

### DETAILED DESCRIPTION OF EMBODIMENTS

Described herein are average current modulation circuits and methods that may be used with conventional AC-DC circuits used to power DC loads such as LEDs, in lighting applications. Embodiments provide a controlled average current output, such that low frequency content is substantially removed from the output. In LED lighting applications, the removal of the low frequency content (i.e., ripple at the 2^{nd} harmonic of the AC line frequency) ensures that the luminous output of the LEDs appears constant to the human eye. Embodiments work in conjunction with AC-DC control circuits to provide a high power factor LED driver, which can be achieved through numerous different circuit topologies. According to the embodiments, a switch (Q_{MOD}) in series with an LED load is modulated at a high frequency, such that any effect on the luminous output of the LED load does not impact the human eye, and such that the average value of the LED current within each modulation cycle is the same. Embodiments substantially remove the low frequency ripple (e.g., 120 Hz in North America or 100 Hz in China, Europe) from the LED current generated by the power factor correction (PFC) stage, without requiring large energy storage capacitors. Thus, long life film or ceramic type capacitors may be used, increasing reliability.

As used herein, the term “substantially” refers to the fact that the DC output power contains only a very small low frequency ripple or no low frequency ripple, such that the DC power is suitable for use in sensitive applications such as LED lighting. However, as noted above, embodiments may be used in applications other than driving LEDs.

Average current modulation circuits and methods feature a simple control scheme, and require minimal changes to existing PFC designs, by adding a single low voltage switch Q_{MOD}, rated the same as the LED output voltage, and a current sense resistor Rₛₑₙₛₑ. The circuits and methods are configured to work with single stage PFC designs, and improve the performance of existing isolated and non-isolated PFC converters, such as, but not limited to, buck-boost, flyback, forward, and buck converters. As the circuits and methods do not interact with the operation of the power switch in the PFC circuit, the power factor is unchanged and remains high.

Embodiments are particularly well-suited to LED lighting applications, because of their high power factor, high efficiency, and reduction or elimination of visible flickering of the light emitting from the LED lamps. Accordingly, embodiments are described herein with respect to such applications. However, it will be appreciated that the embodiments may be applied to other applications; e.g., applications where the load is not an LED. Thus, throughout the description and drawings, the load may include one or more LEDs, or the load may not include any LEDs. In lighting applications, embodiments may be implemented in a LED lamp, or in a separate power supply used to drive one or more LED lamps.

### Operating Principle

### Average Current Modulation

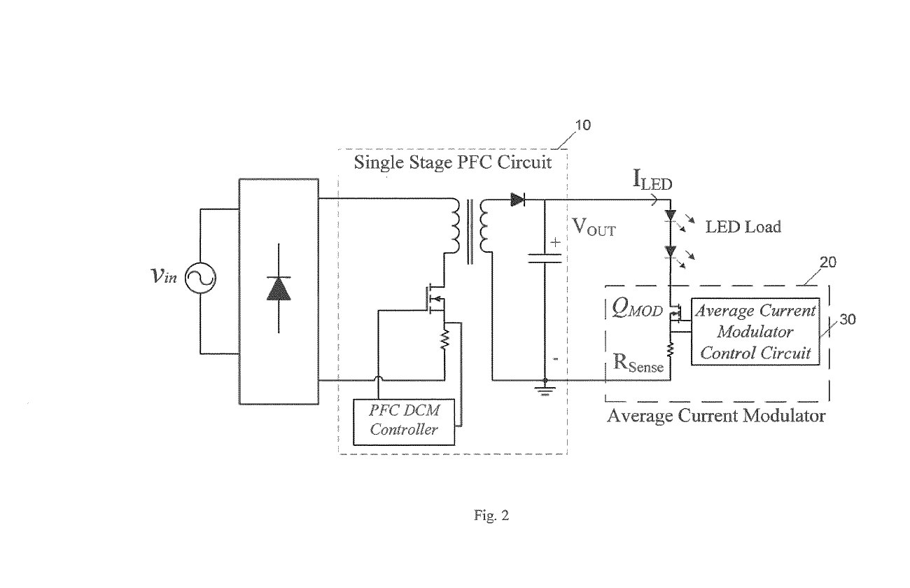

An average current modulation circuit (i.e., a current modulator) as described herein reduces or substantially removes the low frequency current ripple that is normally generated by conventional single stage PFC LED drivers. The embodiment of FIG. 2 shows an average current modulator 20 implemented in a single stage flyback PFC converter 10. In this embodiment the average current modulator 20 includes a modulation switch (e.g., a MOSFET) Q_{MOD}, a current sense resistor. Rₛₑₙₛₑ, and a control circuit 30 that controls the current modulator's operation. Q_{MOD} and Rₛₑₙₛₑ are connected in series with the LED load. There is no need for additional electromagnetic components, and no change to the PFC circuit is required. The voltage rating for Q_{MOD} may be the same as the LED voltage, which, for example, may be less than 60 V, or less than 100 V in other cases. Because of the low voltage rating of Q_{MOD}, and the relatively low complexity of the control circuit, the cost of the modulator is kept very low.

The current modulator switch Q_{MOD} operates in series with the load that is powered by the single stage PFC converter, to modulate the load current at a high modulation frequency f_{mod}. Insofar as the modulation of the load current results in modulation of the light output of the LED load, the modulation frequency is set high enough to keep the LED light modulation above the visible range of human observers, and to avoid audible noise. On the other hand, the modulation frequency is set relatively low so as to minimize switching losses. For example, the modulation frequency may be in the range of 20 kHz to 25 kHz, although it is not limited thereto. The modulation frequency of Q_{MOD} and the switching frequency of the power factor correction circuit need not be the same. For example, the switching frequency of the PFC circuit may be two to three times higher than the modulation frequency.

The average current of the load I_{LED}_{_}_{avg} is controlled for each modulation cycle. As used herein, the term “modulation cycle” refers to a single switching event of Q_{MOD} within one period of the modulation frequency, wherein Q_{MOD} is turned on for a portion of the cycle to control the average current. Each modulation cycle contains one current pulse, and current pulses vary in duty cycle and amplitude. Both the duty cycle and the amplitude of the current pulses contribute to the average current. As a result, the load current includes a DC component and a high frequency component, at the modulation frequency. The modulation substantially removes any low frequency current ripple that would be induced by the voltage ripple of the PFC stage. The LED light output resulting from the high frequency current is proportional to the average LED current, and appears flicker-free as humans do not notice high frequency light modulation.

As described herein, by controlling the average current at a high frequency, the average current modulator can respond to low frequency voltage variation of the PFC output voltage. Therefore, the average current modulator substantially removes or minimizes low frequency LED current from a PFC circuit with significant twice line frequency voltage ripple introduced by small energy storage capacitance. Although the magnitudes of the LED current pulses may fall within the low frequency envelope, the LED current contains little or substantially no content at the low frequency, due to the average current modulator maintaining the average current each modulation cycle.

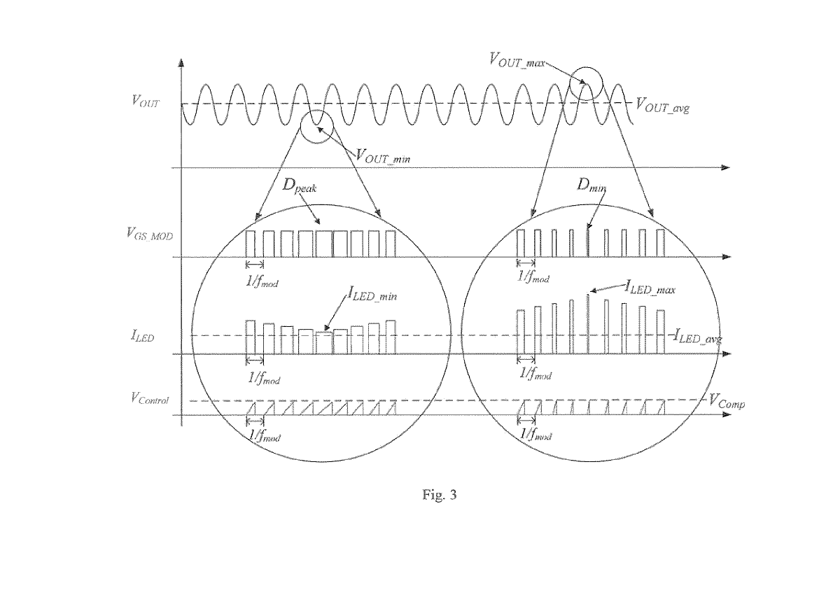

Control of the average current modulator involves turning on Q_{MOD} at the start of each modulation cycle, and integrating the current that flows through the LED load. The switch is turned off once the desired average current has been reached. This action is illustrated in FIG. 3, where the PFC output voltage V_{OUT} has a considerable low frequency ripple (such as 120 Hz). When the Q_{MOD} is turned on, the LED current (km) rises quickly to the level dictated by the instantaneous voltage. The switch remains on as the modulator integrates the LED current. The current integration control signal V_{Control} represents the average current “thus far” within each modulation cycle, and will dictate the Q_{MOD} turn-off instance once the average current has reached the programmed reference value, which is determined when V_{Control} is equal to V_{comp}.

More particularly, FIG. 3 shows the operational waveforms V_{OUT}, gate signal of the modulation switch V_{GS}_{_}_{MOD}, LED load current I_{LED}, and the control signal that dictates the modulation switch turn-off instance, V_{Control}. To illustrate the two extreme operating points of the current modulator's operation, the waveforms of FIG. 3 are zoomed in to isolate the behaviour at the maximum and minimum values of the PFC output voltage, V_{OUT}_{_}ₘₐₓ and V_{OUT}_{_}ₘᵢₙ, respectively. These two operating points highlight the peak duty cycle, Dₚₑₐₖ, which occurs at the minimum LED current pulse, I_{LED}_{_}ₘᵢₙ, and the minimum duty cycle, Dₘᵢₙ, which occurs at the maximum LED current pulse, I_{LED}_{_}ₘₐₓ.

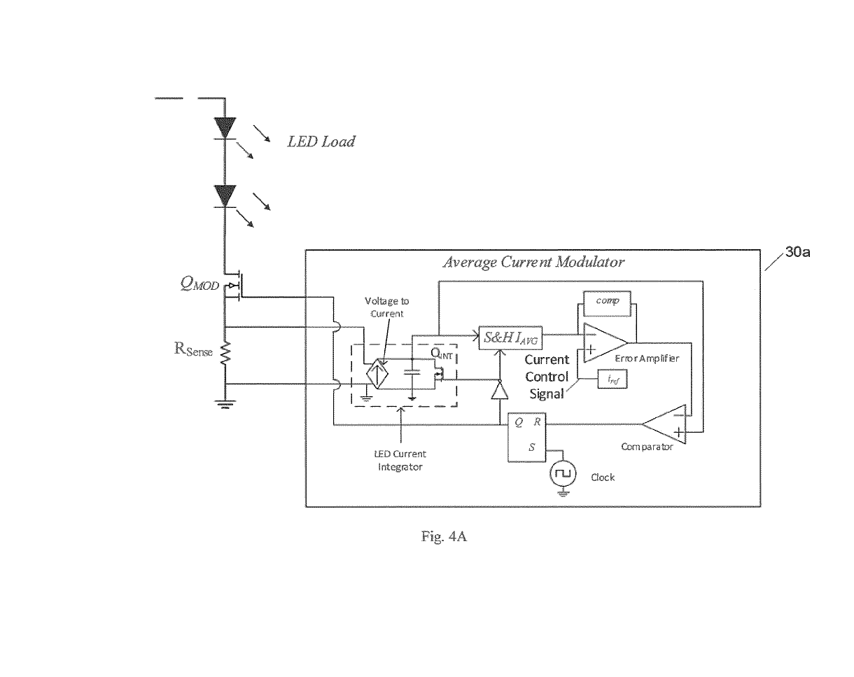

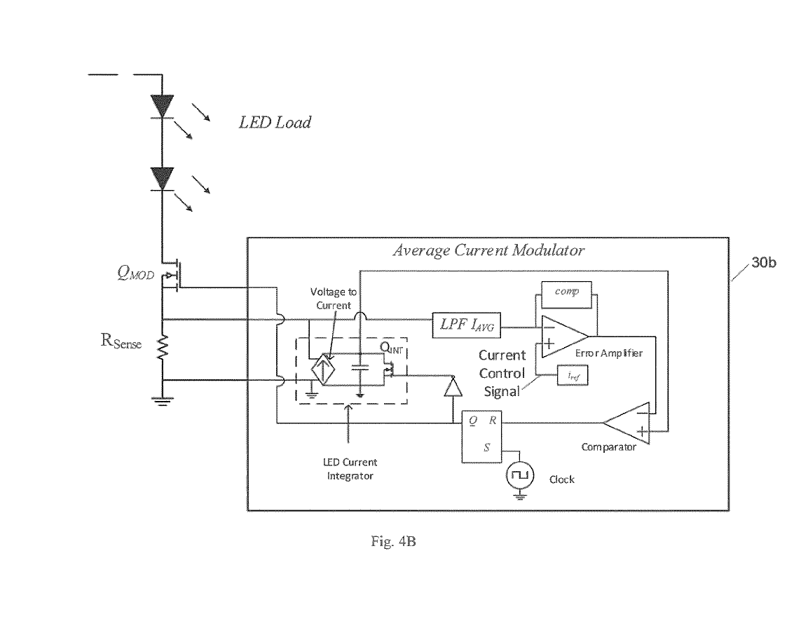

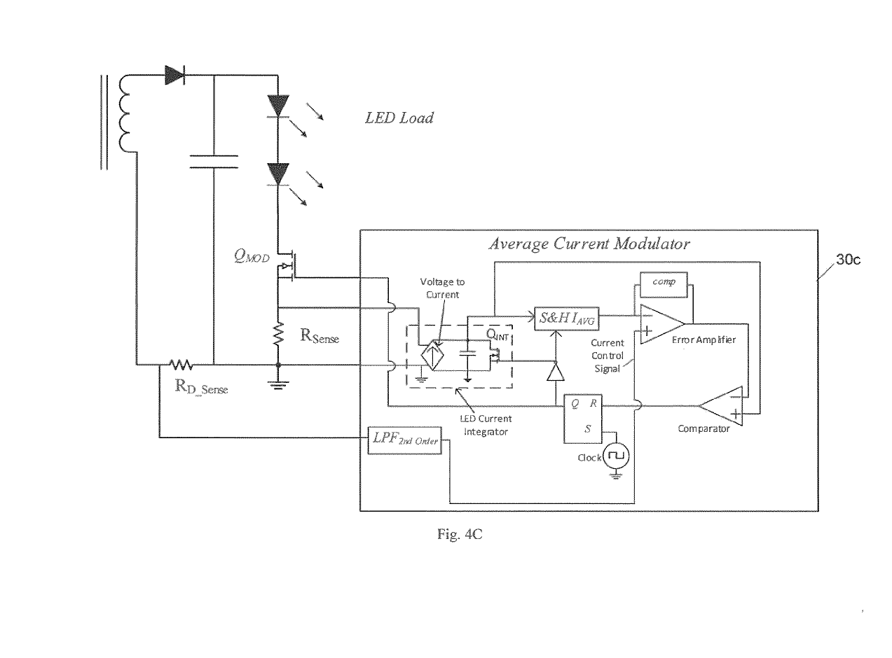

Operation of the average current modulator, and how it controls the average value of LED current in each modulation cycle, is described with reference to FIGS. 4A and 4B. Referring to the embodiment of FIG. 4A, the control circuit 30a controls the switch Q_{MOD} turn-on at the beginning of each modulation cycle, using an internal clock operating at a fixed frequency. Q_{MOD} remains on while the LED current is sensed by the current sensing resistor Rₛₑₙₛₑ and integrated until the desired average value is reached. At this moment, the voltage of the integrator is captured by a sample and hold circuit S&H I_{AVG}. Once this has been completed, Q_{MOD} is turned off and the integrator is reset. The output of the sample and hold circuit is the average value of the LED current for the previous modulation cycle. This value is compared with a current control signal through an error amplifier. In this embodiment the current control signal is obtained from a current reference i_{ref}, which may be, for example, a programmed reference value. The output of the error amplifier is then compared with the instantaneous value of the LED current integrator by a comparator to generate the reset signal that turns Q_{MOD} off.

FIG. 4B shows another embodiment of the control circuit 30b, implemented without a sample and hold circuit. To obtain a constant average LED current over one modulation cycle, the control circuit controls the modulation switch Q_{MOD} turn-on at the beginning of each modulation cycle, via a flip flop and a fixed frequency clock. The LED current is sensed and integrated by an LED current integrator, and once the average current equals an error voltage the modulation switch Q_{MOD} is turned off by the flip flop through a current comparator. The error voltage is generated by an error amplifier, by comparing the average LED current level, which is generated by filtering the LED current with a low pass filter LPF I_{AVG}, to a current control signal. The current control signal may be obtained from i_{ref}, e.g., a programmed reference value. In the embodiment of FIG. 4B, the control circuit 30 may be implemented using two operational amplifiers (op-amps) and a generic PWM controller. The LED current integrator may be implemented using one op-amp, and the low pass filter LPF I_{AVG} may be implemented using one op-amp. The error amplifier, current comparator, fixed frequency clock, and flip flop may be packaged within a PWM controller. The power to turn the modulation switch on and off may be supplied by a gate driver that is also packaged within the PWM controller. For simplicity, the gate driver is not shown, since the flip flop is the component that dictates the turn on and turn off of Q_{MOD}.

Due to the low frequency ripple of the PFC output voltage, the magnitude of the LED current pulses that drive the LED load also vary at this low frequency. As such, the duty cycle of the modulation switch Q_{MOD} will vary, peaking at the minimum PFC output voltage, and reaching a minimum value at the maximum PFC output voltage.

In another embodiment, shown in FIG. 4C, the control circuit 30c uses a current control signal for the average current modulator which is set according to the low frequency average value of the PFC rectifier diode current. Since a constant output current PFC controller may use the average rectifier diode current as its control parameter, the average current modulator may use the current control signal for control of the average LED current.

This embodiment requires sensing the rectifier diode current, which may be achieved by sensing the current flowing from the PFC output back to the main power stage of the PFC converter using a resistor R_{D}_{_}_{Sense}. The sensed diode current is filtered (e.g., by a low pass filter LPF_{2nd order}), which produces a voltage representing the DC value of current flowing through the rectifier diode. This voltage is used as the current control signal for the average current modulator.

The type of filter used, and its characteristics, are key to generating the current control signal within an appropriate amount of time during the PFC stage start-up sequence. For example, a second order low pass filter with a low cut off frequency (e.g., ˜10-20 Hz), and a relatively low damping factor (e.g., ˜0.4) generates the required control signal in an appropriate amount of time such that it does not interfere with the proper operation of the average current modulator.

Particularly, the damping factor significantly affects the time it takes to generate the current control signal. This should be considered because the control method does not directly control the high duty cycle (e.g., 95%) that is desired at the minimum PFC output voltage (V_{OUT}_{_}ₘᵢₙ), but relies on the timing of the current control signal generation to provide a suitable peak duty cycle. During the start-up sequence of the PFC stage, the PFC output voltage rises, and the current control signal rises as well. Once the current control signal reaches the current level determined by the PFC controller, the average value of the PFC output voltage will settle.

To obtain a suitably high duty cycle at the PFC output voltage minimum, the current control signal should reach a stable value after the PFC voltage has risen such that its minimum instantaneous value (V_{OUT}_{_}ₘᵢₙ) will produce a current pulse greater than the current programmed by the PFC stage. This will allow the average current modulator to obtain the average LED current with a duty cycle <100%. If the current control signal reaches its stable value before the PFC voltage has risen to this level, the average current modulator will be unable to produce the desired average current at the PFC output voltage minimum (V_{OUT}_{_}ₘᵢₙ), and the LED current will contain undesirable low frequency content.

If the filter is not properly designed, and the current control signal takes too long to reach its stable value, the PFC output voltage may have risen to a level that produces high current pulses at the PFC voltage minimum, corresponding to a much lower peak duty cycle than desired (e.g., 75% rather than 95%). If this is the case, the output voltage of the PFC stage will produce larger current pulses through the LED load at the maximum value of the PFC output voltage, and may damage the LED device.

### Pulsed Current Limitations of LEDs

Pulsed LED current may be defined by the pulse amplitude and pulse duty cycle. For the embodiments described herein, current pulses do not exceed 100% of the maximum rated current for duty cycles between 51%-100%, current pulses do not exceed 200% of the rated current for duty cycles between 10%-50%, and current pulses with less than 10% duty cycles do not exceed 300% of the rated current. Also, the LED load is rated for a maximum current twice that of the desired average current. This ensures that if the LED load experiences pulses with amplitudes equal to or above the rated current, the duty cycles of these pulses will be equal to or less than 50%. Other limitations may of course be used.

Average current modulator embodiments drive the LED load with current pulses higher than the average current, causing the root mean square (RMS) value of the LED current to be higher than the average LED current. Although the increased RMS LED current may increase the LED junction temperature, any increase is negligible and will not significantly affect the lifetime of the LED.

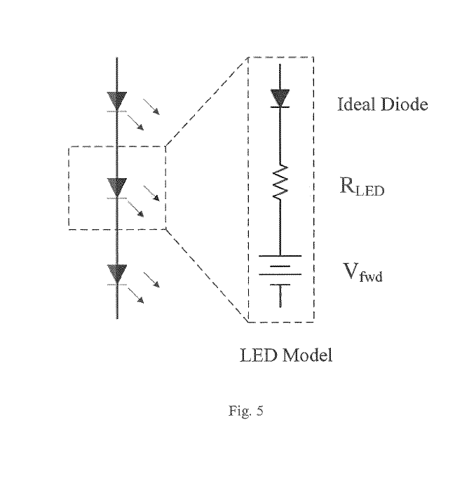

An equivalent circuit model of an LED, shown in FIG. 5, includes an ideal diode, a series resistance, R_{LED}, and a voltage source, V_{fwd}. The power consumed by an LED is largely attributed to the equivalent voltage source, which consumes about 90% of the LED power. The remaining power is dissipated within the equivalent resistance. The power consumed by the equivalent voltage source is proportional to the average value of the LED current, and as the average current is maintained by the current modulator, the associated power loss is unchanged. The power dissipated by the equivalent resistance is proportional to the RMS value of the LED current, and causes a rise in junction temperature. Due to the fact that most of the LED power is associated with the equivalent voltage source, the increase in LED power due to the current modulator is only about 5%, which is negligible.

### PFC Circuit Output Voltage Variation and Peak Duty Cycle Control

In some embodiments, an average current modulator controls the average LED current by modulating the duty cycle of the LED current, and the current pulse amplitudes are not controlled. To avoid high current levels that may damage an LED device, the maximum current pulse amplitude may be limited. The low frequency voltage variation of the PFC circuit output and its relation to the LED current pulses are described below. Peak duty cycle control may be implemented for the modulation switch Q_{MOD}, operating in conjunction with the average current modulator. Peak duty cycle control minimizes current stress of the LED load.

When coupled with an average current modulator, a single stage PFC converter has different control requirements, relative to conventional LED drivers. For example, in average current modulator embodiments, the DC level of the PFC output voltage does not correspond to the programmed average LED current level. Based on the operating principle of the average current modulator, each LED current pulse must be larger than the desired average LED current to achieve zero low frequency current (I_{LED}_{ₚᵤₗₛₑ} (t)>I_{LED}_{_}_{avg}). Thus, the PFC output voltage must be high enough to produce current pulses larger than the desired average current at all points during its low frequency variation. This may be guaranteed if the minimum current pulse produced by the minimum PFC voltage (V_{OUT}_{_}ₘᵢₙ), is larger than the desired average current. The peak duty cycle of the modulator, which occurs at the minimum LED current pulse, is defined in (1). A general expression is given in (2) for all LED current pulses.

$$\begin{matrix}Peak Duty Cycle \% = \frac{{I}_{LED \_ avg}}{{I}_{LED \_ min}} & ( 1 ) \\ Duty Cycle ( t ) \% = \frac{{I}_{LED \_ avg}}{{I}_{{LED}_{pulse}} ( t )} & ( 2 )\end{matrix}$$

The relationship between the PFC voltage and the LED current pulses is dependent on the characteristics of the LED load, and is expressed in (3). An LED load may consist of one LED chip, or two or more LED chips in combination. The resistance and forward voltage of an LED load is dynamic with the forward current, but can be considered constant for a given average output current.

$${I}_{{LED}_{pulse}} ( t ) = \frac{{V}_{OUT} ( t ) - {V}_{fwd}}{{R}_{LED}} \qquad ( 3 )$$

The amplitude of the LED current pulses, I_{LED}_{ₚᵤₗₛₑ}(t) as defined in (3), is the difference between the PFC output voltage, V_{OUT} (t), and the forward voltage of the LED load, divided by the series resistance of the LED load. As the current modulator's modulation frequency is significantly higher than the low frequency variation of the PFC output voltage, V_{OUT}(t) and I_{LED}_{_}ₚᵤₗₛₑ(t) can be considered constant for each modulation cycle of the current modulator. Based on the equivalent circuit model of the LED load (FIG. 5), the minimum voltage of the PFC output is defined in (4), with its limitation expressed in (5).

V_{OUT}_{_}ₘᵢₙ=I_{LED}_{_}ₘᵢₙ·R_{LED}+V_{fwd} (4)

V_{OUT}_{_}ₘᵢₙ≧I_{LED}_{_}_{avg}·R_{LED}+V_{fwd} (5)

From (3), it is noted that the amplitudes of the LED current pulses vary proportionally to the low frequency variation of the PFC output voltage, and that from (2) the duty cycle of the modulation switch varies inversely with the PFC output voltage. As the output voltage increases, the duty cycle decreases, and as the output voltage decreases, the duty cycle increases. The maximum value of the output voltage, V_{OUT}_{_}ₘₐₓ, produces the maximum LED current pulse amplitude, I_{LED}_{_}ₘₐₓ, as expressed in (6). The maximum output voltage may also be expressed as the minimum output voltage plus the peak to peak voltage ripple of the PFC output, V_{OUT pk-pk}, as given in (7). This output voltage ripple is dependent on the energy storage capacitance used in the PFC stage, and the average LED current, defined in (8), where fₗᵢₙₑ is the line frequency (60 Hz in North America, 50 Hz in Europe, China) and Cₒᵤₜ is the capacitance value.

$$\begin{matrix}{V}_{OUT \_ max} = {I}_{LED \_ max} \cdot {R}_{LED} + {V}_{fwd} & ( 6 ) \\ {V}_{OUT \_ max} = {V}_{OUT \_ min} + {V}_{OUT pk - pk} & ( 7 ) \\ {V}_{OUT pk - pk} = \frac{{I}_{{LED}_{avg}}}{2 π \cdot {f}_{line} \cdot {C}_{out}} & ( 8 )\end{matrix}$$

The voltage ripple of the PFC circuit may be expressed using the maximum and minimum LED current pulses and the resistance of the LED load by combining (4), (6) and (7) to produce (9). By combining (8) and (9), the required PFC stage capacitance can be determined once the maximum and minimum LED current pulses are defined. This expression is given in (10).

$$\begin{matrix}{V}_{OUT pk - pk} = ( {I}_{LED \_ max} - {I}_{LED \_ min} ) \cdot {R}_{LED} & ( 9 ) \\ {C}_{out} = \frac{{I}_{LED \_ avg}}{2 π \cdot {f}_{line} \cdot ( {I}_{LED \_ max} - {I}_{LED \_ min} ) \cdot {R}_{LED}} & ( 10 )\end{matrix}$$

High amplitude current pulses may damage LEDs, and left uncontrolled, may pose a danger to the long term reliability of the devices. As such it is important to limit the maximum LED current pulse amplitude. Considering a single stage PFC circuit with a fixed energy storage capacitor, and therefore a fixed output ripple, the maximum output voltage may be considered as an offset of the minimum voltage level. If the minimum voltage level is controlled close to its minimum permissible value in (5), the maximum voltage level can be limited accordingly. This in turn limits the maximum LED current pulse amplitude.

It is noted that the minimum PFC voltage and minimum LED current pulse correspond with the peak duty cycle of the average current modulator at the modulation frequency. To control the minimum LED current pulse such that the maximum LED current pulse amplitude is limited, the average current modulator controls the peak duty cycle of the modulation switch. By using the peak duty cycle as a control variable in the modulation loop, the controller becomes independent of the LED load characteristics, ensuring proper operation regardless of the LED load.

Considering an LED load (e.g., R_{LED}=20Ω, V_{fwd}=40 V) that is powered by a single stage PFC circuit and an average current modulator, the benefits of peak duty cycle control may be illustrated. Generally, the peak duty cycle should be set so that maximum current pulse is equal to or lower than the current limit for a given load. For example, the PFC circuit is assumed to have an output voltage ripple of 6 Vₚₖ₋ₚₖ and the average current modulator is set to control the average LED current at 200 mA. If the minimum PFC voltage achieves the average LED current by modulating the LED current with a 70% duty cycle, the minimum LED current pulse will be 285 mA based on equation (2). The maximum LED current pulse will be 240 mA higher, from equation (9), at 525 mA, with a duty cycle of 38% from equation (2). With a peak duty cycle of 90% the minimum LED current pulse will be 222 mA, and the maximum current pulse will be limited to 462 mA, down from 525 mA. If the peak duty cycle is set to 90%, the minimum current pulse can be controlled, which in turn limits the maximum current pulse. Therefore, it is desirable to set the peak duty cycle of Q_{MOD} as close to 100% as possible to limit the peak LED current. In some embodiments, a peak duty cycle of about 90% is selected as the desired peak duty cycle. In other embodiments, the desired peak duty cycle may be selected to be from about 85% to about 95%, depending on control circuit capabilities, desired current levels, among other factors.

### Peak Duty Cycle Control

Two strategies may be employed for controlling the peak duty cycle. According to one strategy, the PFC output voltage is adjusted to control the peak duty cycle. In embodiments implementing this strategy, the average LED current is set by the current modulation circuit, and the PFC circuit is adjusted to control the output voltage. According to another strategy, the current control signal within the average current modulator is adjusted to control the peak duty cycle. In embodiments employing this strategy, modulation of the LED load current by the average current modulator indirectly adjusts the average output voltage of the PFC converter to achieve the desired peak duty cycle at the programmed current level, e.g., such that the average current of the LED load matches the average current delivered by the PFC converter. In these embodiments, the average LED current will be determined by the PFC control loop. Thus, these embodiments function with power factor correction circuits that feature dimming capabilities.

### Peak Duty Cycle Control—Output Voltage Adjustment

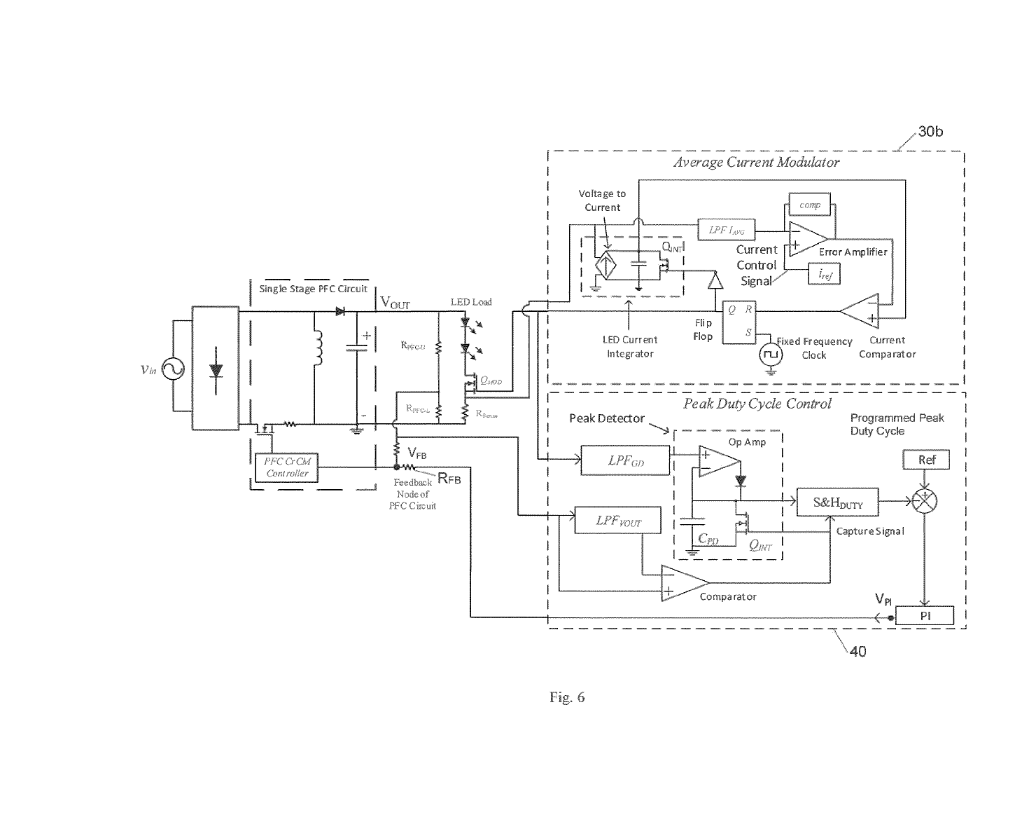

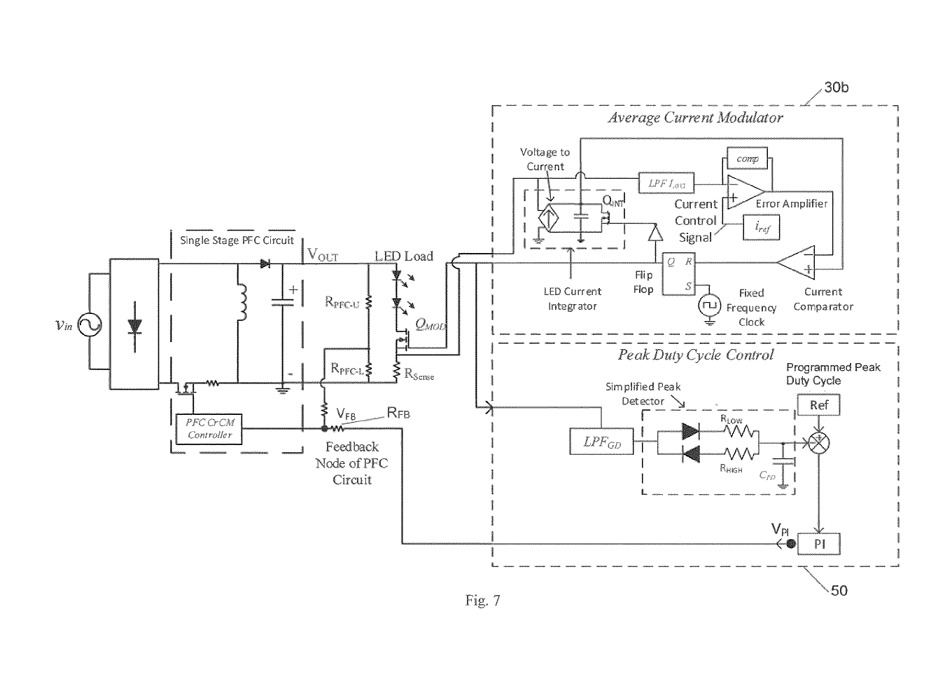

Embodiments wherein the PFC output voltage is adjusted may be implemented in non-isolated PFC circuits where a direct connection can be made between the peak duty cycle circuit and the PFC controller, examples of which are shown in FIGS. 6 and 7. The detected peak duty cycle and the desired peak duty cycle are compared to create an error voltage, which is added to the feedback voltage of the PFC circuit. In this way, the voltage level of the PFC output is adjusted to ensure that the desired peak duty cycle is achieved. In this embodiment, the LED current level is set by the average current modulator, not the PFC circuit.

Referring to FIG. 6, a peak duty cycle control circuit 40 adjusts the output voltage to control the peak duty cycle. The average current modulator 30b may be the same as that shown in FIG. 4B, or the average current modulator 30a of FIG. 4A may be used. To detect the peak duty cycle, the PWM gate drive signal of the modulation switch Q_{MOD} is filtered to produce a continuous waveform that represents the varying duty cycle of the average current modulator. This is accomplished by a low pass filter LPF_{GD} with a cut-off frequency significantly lower than the modulation frequency. The peak duty cycle is detected from this waveform by a peak detector circuit (op-amp, diode, capacitor C_{PD}, and reset switch Q_{INT}), which holds the maximum voltage applied to its input with a sample and hold circuit S&H_{DUTY}. The capture signal, which instructs the sample and hold circuit to sample the peak detector voltage, is generated from the ripple voltage of the PFC output using a low pass filter LPF_{VOUT} and a comparator. The comparator generates a square wave corresponding to the ripple ‘high’ and ‘low’, which is used as control signal for the sample and hold circuit (S&H_{DUTY}) and reset switch, to capture the peak value of the duty cycle each low frequency period. The capture signal is generated once the peak duty cycle is reached. In this way, the capture signal is used to sample the voltage of the peak detector when it holds a voltage representing the peak duty cycle of the modulation switch.

Once the peak duty cycle is detected, it is compared to a reference voltage (Ref) representing a desired high peak duty cycle (e.g., 90%). The error voltage from this comparison is then used to adjust the output of the PFC converter using a PI feedback loop. This may include converting the error voltage into a current. The error voltage is fed to the feedback node of the PFC circuit and the PFC controller via a relatively large (e.g., 5-100 kΩ) resistor R_{FB}.

To maintain balance, the PFC controller may adjust the average output voltage (V_{OUT}) such that the combination of both feedback paths will produce a stable feedback signal for the PFC controller. For example, when the peak duty cycle is below a selected level (e.g., below 90%), the output voltage of the PI block (V_{PI}) increases, causing the voltage at the feedback node of the PFC circuit (V_{FB}) to increase. The PFC controller responds by decreasing the DC output voltage (V_{OUT}), which increases the peak duty cycle so that the same average current is achieved. When the peak duty cycle is above the desired level, the output voltage of the PI block decreases, causing the feedback node voltage of the PFC circuit to decrease. The PFC controller responds by increasing the output voltage, which causes the peak duty cycle to decrease. In this way, the error voltage of the peak duty cycle comparison adjusts the DC output voltage of the PFC converter such that the minimum PFC voltage produces the desired peak duty cycle in the average current modulator.

The output voltage adjustment requires four op-amps, one each for the peak detector, LPF_{GD}, LPF_{VOUT}, and the PI block. As well, it requires a comparator for the peak comparator and a circuit for the sample and hold, S&H_{DUTY}. The op-amps and sample and hold may be implemented using integrated circuits (ICs).

FIG. 7 shows an embodiment with a simplified peak detector, which requires fewer ICs. This embodiment approximates the peak duty cycle without the use of a traditional peak detector or sample and hold circuit. The average current modulator 30b may be the same as that shown in FIG. 4B, or the average current modulator 30a of FIG. 4A may be used. Referring to FIG. 7, the PWM gate drive signal of the modulation switch Q_{MOD} is filtered to produce a continuous waveform that represents the varying duty cycle of the average current modulator. This is accomplished by a low pass filter LPF_{GD} with a cut-off frequency significantly lower than the modulation frequency. The duty cycle waveform is fed into a simplified peak detector having two unidirectional sensing paths. The sensing paths, a forward (low impedance) path and a reverse (high impedance) path charge and discharge a capacitor C_{PD} to generate a voltage waveform representing the peak duty cycle. The path directions may be implemented using diodes, and resistors R_{LOW} and R_{HIGH} are used to control the impedance of each path.

At the peak of the duty cycle waveform, the forward path diode is forward biased and the small time constant results in the peak detector output voltage being quickly charged to a voltage level representing the peak duty cycle. Through the rest of the low frequency period the peak detector ideally holds this voltage level, though for stability reasons this is inadmissible. Instead, the reverse sensing path's high impedance causes the capacitor C_{PD} to discharge slowly, such that the voltage of the detector does not change significantly over a single low frequency period. As the duty cycle waveform reaches the voltage level representing the next peak duty cycle, the peak detector voltage is again quickly charged to this level.

The reverse sensing path discharges the capacitor over several low frequency periods. This is required so that the controller can adjust the system in case the peak duty cycle voltage ever saturates, which is likely to occur during the start-up sequence. The capacitor voltage decrease within one low frequency period does not significantly impact the steady state operation of the average current modulator.

For example, as the duty cycle decreases, the output voltage of the peak detector remains high (roughly at the peak duty cycle) and the reverse path diode becomes forward biased (while the forward path diode becomes reverse biased) and the large time constant dictates the filtering action. During the remainder of the low frequency period, as the duty cycle reaches its minimum value and subsequently begins to rise again, the large time constant maintains the value of the peak detector's output. The value of the large time constant is designed such that the reverse path does not significantly affect the peak detector's output within a single low frequency period. The reverse path lowers the peak detector's output over multiple low frequency time periods, in case of abnormal circuit behaviour during the PFC stage's start-up or other unforeseen events. Without the reverse path, once the peak detector sees a high duty cycle, it is unable to lower its output regardless of any other circuit behaviour, and would not be able to stabilize the system in such a case.

The simplified peak detector produces a voltage that accurately represents the peak duty cycle of the average current modulator using a limited number of passive components. For example, in this embodiment the output voltage adjustment only requires two op-amps to implement the LPF_{GD} and the PI blocks. The cost of the diodes and resistors is negligible.

### Peak Duty Cycle Control—Average Current Adjustment

In average current adjustment embodiments, the average LED current level within the average current modulator, i.e., the current control signal, is adjusted to control the peak duty cycle. These embodiments are suitable for both isolated and non-isolated PFC circuits, as no connection is required between the PFC controller and the peak duty cycle circuit. The detected peak duty cycle and the desired peak duty cycle are compared to create an error voltage, as in the previously described embodiments, and the error voltage is used as the current control signal for the average current modulator (which no longer has a fixed or programmed current reference). By adjusting the average LED current level, the desired peak duty cycle is ensured. Embodiments may employ an average current modulator as shown in FIG. 4A or 4B.

According to average current adjustment embodiments, the DC LED current is set by the PFC controller. In steady state operation, the current control signal of the average current modulator matches the current reference of the PFC controller. Therefore, the average current adjustment allows the average current modulator to work with dimming capable PFC circuits, such as those designed to work with common phase cut dimmers. Using the previously described simplified peak detector, the peak duty cycle control circuit may be implemented as an integrated part of the average current modulator, with no external connections required.

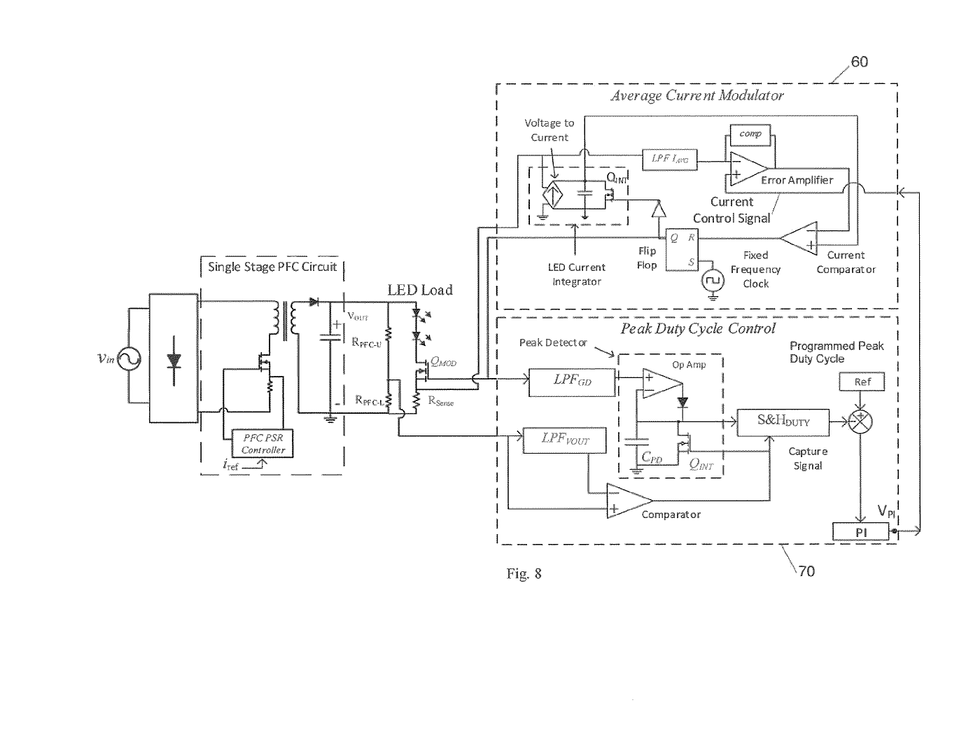

An average current adjustment embodiment is illustrated in FIG. 8. Referring to FIG. 8, the embodiment includes a peak detector with a sample and hold circuit. The LED load in this embodiment is powered by a primary side regulated (PSR) flyback PFC circuit. In this embodiment the average current modulator block 60 is based on the circuit shown in FIG. 4a, except that the current control signal is the output of the PI block from the peak duty cycle comparison of the peak duty cycle controller 70. This embodiment requires four op-amps, one each for the peak detector, LPF_{GD}, LPF_{VOUT}, and the PI block. As well, it requires a comparator for the peak detector and a sample and hold IC for S&H_{DUTY}.

In this embodiment the current control signal for the average current modulator is generated by detecting the peak duty cycle of Q_{MOD} and adjusting the current control signal so that a high duty cycle is achieved at the minimum PFC output voltage (V_{OUT}_{_}ₘᵢₙ). The control operates similarly to the direct PFC output voltage adjustment embodiment described above, in that the gate drive signal of Q_{MOD} is filtered by a low pass filter LPF_{GD} to generate a waveform representing its duty cycle. The detected peak duty cycle during each low frequency period is compared to a reference signal to produce an error voltage. The error voltage is conditioned by a PI block, which may include signal conditioning circuitry, to produce the current control signal for the average current modulator, such that the desired high duty cycle (e.g., 95%) is achieved at the minimum PFC output voltage (V_{OUT}_{_}ₘᵢₙ).

The PFC controller controls the DC component of the LED current from the primary side of the flyback transformer and the average current modulator pulses the LED load. When the peak duty cycle is below the desired level, the output voltage of the PI block (V_{PI}) increases, increasing the current control signal for the current modulator. As the average current level of the modulator increases, the peak duty cycle increases to achieve this average current. When the peak duty cycle is above the desired level, the output voltage of the PI block decreases, decreasing the average current level of the current modulator. As the average current level decreases, the peak duty cycle decreases so that the programmed average current is achieved. As the peak duty cycle control loop and the PFC control loop balance, the PFC output voltage is indirectly adjusted such that the desired peak duty cycle is achieved.

If the current reference of the PFC controller is changed, for example during dimming applications, the DC current of the LED load will change accordingly. Through the control action described above, the average current modulator and the peak duty cycle circuit will adjust the average LED current level to obtain the desired peak duty cycle, at the average current level dictated by the PFC controller.

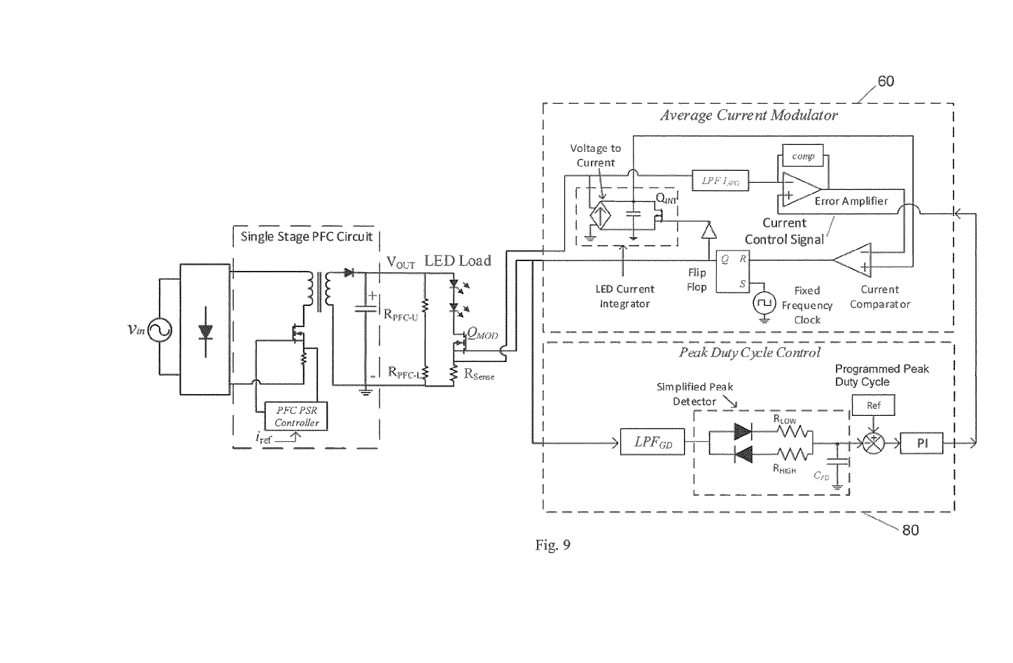

In average current adjustment embodiments the peak duty cycle detection may be accomplished by either of the two ways previously described, i.e., with a traditional peak detector, or with the simplified design. An embodiment using a simplified peak detector connected to the average current modulator is illustrated in FIG. 9. The behaviour of the PI block to control the peak duty cycle is the same as described above. It is noted that by using the simplified peak detector with average current adjustment, peak duty cycle control can be added to the average current modulator control circuit without requiring any external connections. As well, with the simplified peak detector, the average current adjustment only requires two op-amps, for LPF_{GD} and the PI block. The cost of the added diodes and resistors is negligible.

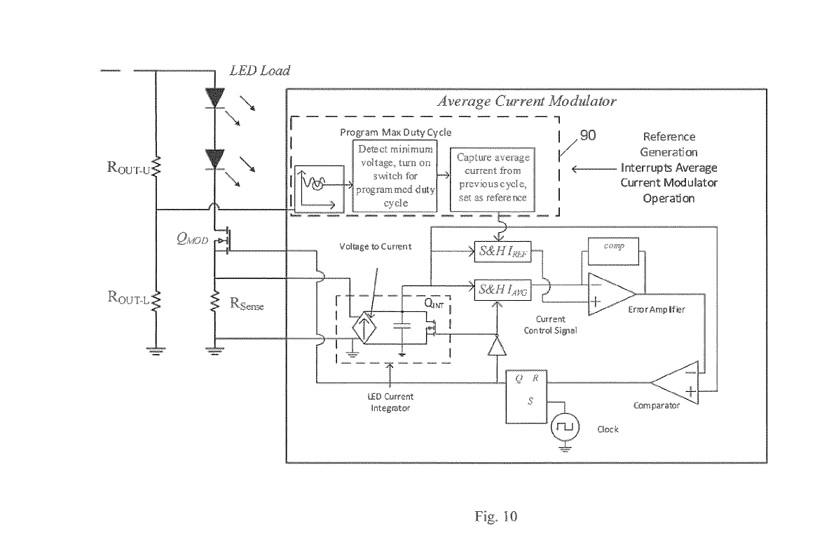

In the embodiment shown in FIG. 10, the current that the average current modulator can achieve at the minimum PFC output voltage (V_{OUT}_{_}ₘᵢₙ) level is measured. The controller 90 then uses this as the current control signal for its operation. During the initial start-up period of the PFC controller, Q_{MOD} remains on (i.e., a duty cycle of 100%) until the first PFC output voltage minimum is detected. At this point, Q_{MOD} is turned on for a fixed high duty cycle (e.g., 95%). At the end of this cycle, the voltage of the LED current integrator is sampled by a separate sample and hold circuit (S&H I_{REF}). The voltage of this sample and hold circuit is held and used as the current control signal of the average current modulator. The average current modulator operation is otherwise the same as described above, except that a new current control signal is sampled at each PFC output voltage minimum (V_{OUT}_{_}ₘᵢₙ). This operation ensures that a high duty cycle is achieved at the PFC output voltage minimum (V_{OUT}_{_}ₘᵢₙ) by making full use of the voltage supplied by the PFC stage. As the PFC stage controls the current output, the average PFC output voltage (V_{OUT}) is adjusted until the average current modulator is supplied with sufficient voltage to provide the LED load with a regulated average current throughout the low frequency period.

Embodiments described herein may be used with existing single stage PFC circuits to reduce low frequency ripple and improve reliability. That is, embodiments comprising an average current controller and optionally a peak duty cycle controller may be added to existing PFC circuits. Depending on the embodiment used, only minor modification of the PFC circuit may be required. For example, an average current modulator 20 as shown in FIG. 2 may be added to an existing PFC circuit by simply connecting the average current modulator between the LED load and ground. As another example, use of an embodiment as shown in FIG. 9 may be added to an existing PFC circuit by simply connecting the average current modulator and peak duty cycle controller between the LED load and ground.

### Dimming Functionality

Dimming may be added to the average current modulator, regardless of which peak duty cycle control circuit is used. With the output voltage adjustment method, the average LED current level may be set by the current control signal within the current modulator. Dimming control may be implemented by adjusting the current control signal within the modulator. By changing the current control signal, the average LED current level changes accordingly. The output voltage adjustment circuit adjusts the output voltage level of the PFC converter to ensure that the programmed peak duty cycle is achieved at every dimming level.

With the average current adjustment method, the average LED current level is set by the current reference within the PFC control circuit. Dimming control may be implemented by adjusting the current reference within the PFC control circuit. The average LED current level changes as the current reference of the PFC circuit changes. The average current adjustment circuit adjusts the current control signal within the current modulator to ensure that the programmed peak duty cycle is achieved at every dimming level. As numerous PFC control circuits available on the market feature dimming capability, using the average current adjustment method offers the simplest way to add dimming functionality to the average current modulator.

### Advantage of Peak Duty Cycle Control

By comparing the maximum LED current with different peak duty cycles, the advantage of the proposed peak duty cycle control method is shown. An analysis of an example LED driver, based on a Buck-Boost PFC stage designed to operate at ˜50 V/175 mA (8.75 W), will show that the maximum LED current is limited when the peak duty cycle is controlled.

To demonstrate advantages of the peak duty cycle control embodiments, a comparison was made based on an 8.75 W buck-boost LED driver without and with peak duty cycle control. For the LED load, 14 LED chips were used (Cree XLAMP ML-C LED). At an average current of 175 mA, each LED has a series resistance of ˜2.67Ω, with a forward voltage of ˜2.9 V. Using 14 LEDs, the resultant LED load has a resistance of 37.38Ω, and forward voltage of 40.6 V. In this comparison, it is assumed that the average current modulator is used to condition a single stage PFC circuit that has an 8 Vₚₖ₋ₚₖ output voltage ripple. With a 60 Hz power source, the required energy storage capacitance is calculated from (8) to be 58 μF.

First, without peak duty cycle control, it is assumed the PFC output voltage level is such that the minimum LED current pulse amplitude is 250 mA. This pulse occurs at a duty cycle of 70% based on (1). According to (4), the minimum PFC output voltage is 49.95 V, while the maximum PFC output voltage is 57.95 V based on the peak to peak PFC circuit voltage ripple and (7). From (6), the maximum LED current pulse is 464 mA.

With peak duty cycle control implemented with the average current modulator, the PFC output voltage is adjusted to obtain the programmed high duty cycle. If a peak duty cycle of 90% is obtained, the amplitudes of the LED current pulses will be reduced. The minimum current pulse is 195 mA, dictated by the peak duty cycle. Subsequently, the minimum and maximum PFC voltage levels are calculated to be 47.89 V and 55.89 V respectively. This leads to a maximum current pulse of 409 mA.

Table 1 summarizes the conditions of the two driver systems, without and with peak duty cycle control. The data show that while both drivers have the same average LED current and use the same output capacitor, the maximum LED current is lower when peak duty cycle control is used. By programming a high peak duty cycle (e.g., 90%), the maximum LED current amplitude is reduced without having to increase the PFC stage energy storage capacitance.

TABLE 1
COMPARISON OF LED DRIVER WITHOUT
AND WITH PEAK DUTY CYCLE CONTROL

| | | Value | | | |
|---|---|---|---|---|---|
| | | Without | | With | |
| | | Peak Duty | | Peak Duty | |
| | | Cycle | | Cycle | |
| Symbol | Quantity | Control | | Control | |
| I_{LED}_{_{—}}_{avg} | Average LED Current | 175 | mA | 175 | mA |
| V_{OUT pk-pk} | Output Voltage Ripple | 8 | V | 8 | V |
| Cₒᵤₜ | PFC Capacitance | 56 | μF | 56 | μF |
| I_{LED}_{_{—}}ₘᵢₙ | Minimum LED Current | 250 | mA | 195 | mA |
| V_{OUT}_{_{—}}ₘᵢₙ | Minimum PFC Voltage | 49.95 | V | 47.89 | V |
| V_{OUT}_{_{—}}ₘₐₓ | Maximum PFC Voltage | 57.95 | V | 55.89 | V |
| I_{LED}_{_{—}}ₘₐₓ | Maximum LED Current | 464 | mA | 409 | mA |

### Design Procedure to Minimize PFC Capacitance

An exemplary design procedure is presented based on an LED driver with a flyback PFC stage operating at ˜50 V/500 mA (25 W).

Peak duty cycle control allows the average current modulator to achieve its full potential by ensuring that the minimum LED current pulse is very close to the programmed average current. This control may be used to minimize the energy storage capacitance within the PFC circuit while ensuring that the maximum LED current does not damage the LED load. From (10), the required PFC capacitance can be calculated once the maximum LED current is defined (as the minimum LED current is defined by the peak duty cycle).

The maximum LED current is restricted by the current rating of the LED load. The maximum LED current pulse is chosen by selecting a minimum duty cycle of, for example, 50%, and is calculated from (2). A minimum duty cycle of 50% may be selected for several reasons. The maximum LED current pulse will not damage the LED load as it will be rated for a maximum current equal to twice the average current. As the LED is capable of operating at this maximum LED current under DC operation, any light ripple induced by the LED non-linearity is expected to be minimal.

For the LED load, 20 LED units (OSRAM Golden Dragon Plus LUW-W5AM) are used. At an average LED current of 500 mA, each LED has a series resistance of ˜0.67 ohms, and a forward voltage of 2.1 V. Using 20 LEDs, the resultant LED load has a resistance of 13.4Ω, and forward voltage of 42.0 V.

With the peak duty cycle set at 90%, the minimum LED current pulse will be 555 mA from (1). The maximum LED current is selected using a minimum duty cycle of 50%, calculated to be 1.0 A from (2). Using (10), the capacitor value is calculated to be 198 μF. This is the minimum amount that the average current modulator, with peak duty cycle control, needs to ensure zero low frequency LED current given the set minimum and maximum LED current pulses.

### LED Current Pulse Limit

An independent control loop may be added to the embodiments described herein to limit the magnitude of the LED current pulse. For example, the LED current may be limited to a maximum current selected to prevent damage to the LED load, or to another selected value. Such a control loop may operate by controlling the modulation switch Q_{MOD} gate voltage level when the average current modulator turns the switch on. In one embodiment, the LED current pulse magnitude is compared against a programmed maximum current pulse value. The control loop operates such that the output of the comparison (e.g., an op-amp) will be in one of two states when Q_{MOD} is on. The op-amp output will either swing to its maximum capable value (not restricting the LED current pulse magnitude), or be equal to the precise gate voltage of Q_{MOD} that allows the programmed LED current to flow (limiting the LED current to the programmed maximum current pulse value).

In the first state, when the LED current pulse magnitude is lower than the programmed value, the op-amp output will swing to its maximum possible value, very close to the positive supply voltage. The LED current level is in this state limited by the LED driver and LED load characteristics, independent of the modulation switch characteristics. In this state, the system behaves exactly the same as described above, where the average current modulator controls the average value of LED current without regard for the magnitude of the LED current pulse. The modulation switch operates in saturation mode, where the magnitude of the current flowing through it, and the LEDs, is not dependent on the switch.

In the second state, when the LED current pulse magnitude reaches the programmed current, the output voltage of the op-amp will decrease and bring the modulation switch into the linear (ohmic) operating region (i.e., linear mode). In linear mode, the current flowing through the switch is dependent on the gate voltage. The op-amp voltage will settle to the gate voltage of the switch that allows the programmed current to flow through the switch (and thus the LEDs). This may be used to limit the magnitude of the LED current pulse to a programmed maximum value, preventing damage to the LEDs. The addition of this control loop does not interfere with the operation of the average current modulator to control the average value of the LED current each modulation cycle. The average current modulator operates regardless of the magnitude of the LED current pulse, as the turn-off instance of the modulation switch is determined by the integration of the LED current. Thus the addition of the loop to limit the LED current pulse will not interfere with the functionality of the modulator.

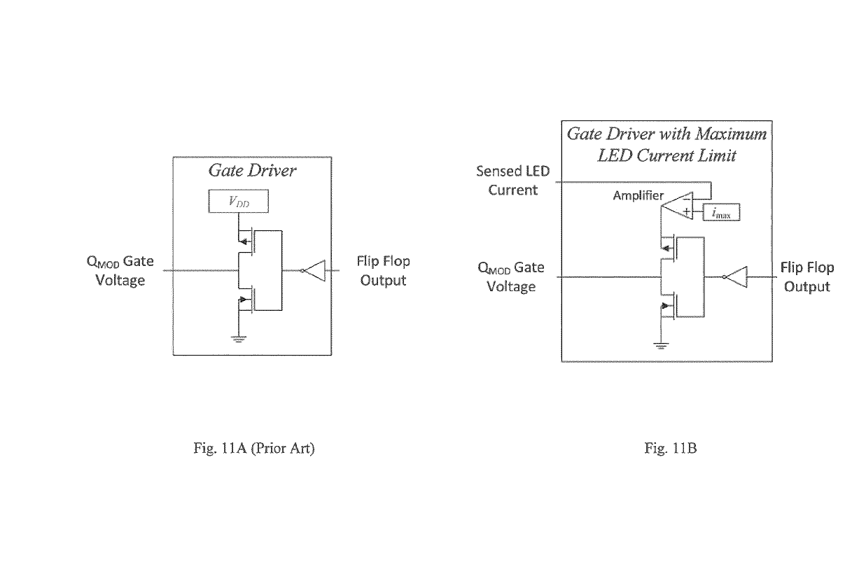

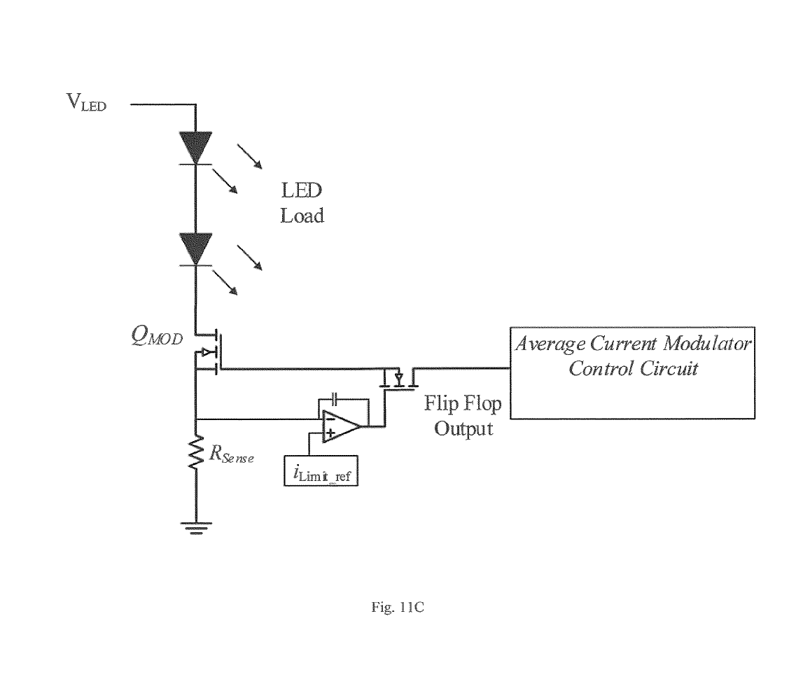

In further embodiments the LED current limiting loop may be implemented by modifying the power supply connection of the gate driver that controls the modulation switch. FIG. 11A shows a typical gate driver. One such modification is shown in FIG. 11B. According to this embodiment, the output of the op-amp used to compare the LED current to the programmed current value is connected to the PMOS switch within the totem pole driver. The op-amp output replaces the power supply V_{DD} within the modulation switch gate driver.

In another embodiment, implementation of the LED current limiting loop requires a single NMOS switch and op-amp, as shown in FIG. 11C. By connecting an NMOS switch in series with the gate drive path of the modulation switch, the logic state of the modulation switch is controlled by the average current modulation control circuit, and the LED current pulse level is controlled by the gate voltage of this second switch. The gate voltage of this second switch is controlled based on the sensed LED current and the programmed current limit. In this embodiment, as the gate voltage is decreased, the voltage drop across its channel increases. This lowers the gate voltage of the modulation switch Q_{MOD} (the voltage supplied by the average current modulator driver is divided between the second switch and the gate of the modulation switch), which limits the LED current pulse magnitude.

Embodiments will be further described by way of the following non-limiting Examples. For the sake of brevity, certain practical design considerations, such as power loss and parasitic elements, are ignored in the Examples.

### Example 1. Buck-Boost LED Driver with Output Voltage Adjustment

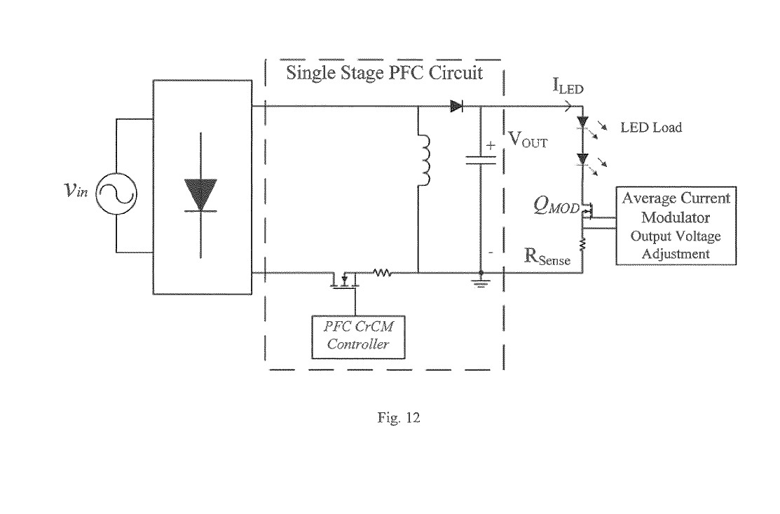

A non-isolated buck-boost LED driver was built as shown in FIG. 12 and tested to demonstrate the operation of the average current modulator with output voltage adjustment for peak duty cycle control. The output was designed to operate at ˜50 V/175 mA for 8.75 W of power from a 60 Hz supply. The LED load was configured with 14 LED chips (Cree MLCAWT-A1-0000-000WE7CT). Rated for a maximum DC current of 350 mA, the LEDs exhibit a forward voltage of 2.9 V, and series resistance of 2.67Ω at 175 mA. Thus the resistance of the entire LED load was 37.38Ω. The average current modulator component list is provided in Table 2.

TABLE 2
AVERAGE CURRENT MODULATOR COMPONENT LIST

| Component | Part | Quantity | Manufacturer |
|---|---|---|---|
| Modulation | 1RFL014NPBFCT | 1 | International |
| MOSFET | | | Rectifier |
| Current Sense | 0.1 Ohm | 1 | Standard |
| Resistor | | | |
| Control | PWM Controller | 1 | Texas |
| Circuit | (UCC38C43) | | Instruments |
| | Operational | 4 | Texas |
| | Amplifier | | Instruments |
| | NAND Gate | 1 | Texas |
| | | | Instruments |

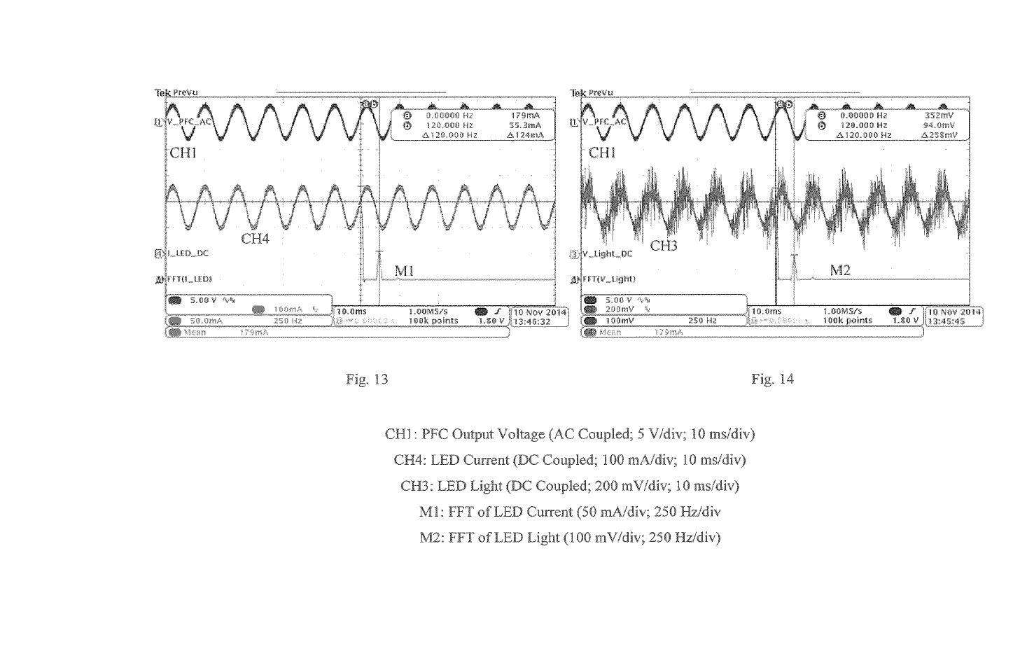

A conventional single stage PFC buck-boost LED driver was built and analyzed to provide a reference to measure the performance of the average current modulator. The buck-boost PFC circuit was designed and implemented with the FAN7529 Critical Conduction Mode PFC Controller from Fairchild. Waveforms of LED current and light are presented in FIGS. 13 and 14, respectively. The fast-fourier transform (FFT) of the LED current and light were used as a metric to compare the attenuation of low frequency current ripple and light ripple of the LED load between the two power supplies. The energy storage capacitance was selected such that the PFC output carried a voltage ripple of approximately 8 Vₚₖ₋ₚₖ. For an average output current of 175 mA, this was calculated from (8) to be 58 μF. Therefore, a 56 μF capacitor was used (a standard value).

The FFT analysis was done by the MATH function of the Tektronix DPO 3034 oscilloscope (in the figures, traces are labelled as M, M1, M2, etc.). The LED light was sensed by a light to voltage sensor, configured using a photodiode (OSRAM SFH 2701) and a transimpedance amplifier (Texas Instruments OPA381). The bandwidth of the sensor was set very high (˜500 kHz), to accurately follow the high frequency waveform of the LEDs.

As shown in FIG. 13, the conventional buck-boost LED driver load current had a 120 Hz ripple of 55.3 mAᵣₘₛ with a DC current of 179 mA, or 43% modulation index defined as peak ripple value to average LED value (55.3 mA*1.414/179 mA). FIG. 14 shows that the light produced by the LED load had a 120 Hz modulation index of 37.7% (94 mV*1.414/53 mV).

For the buck-boost LED driver with the average current modulator, a 10 nF capacitor was connected across the LED load to prevent voltage spikes caused by the modulation method. The voltage across this small capacitor was not discharged by the modulation method and therefore had no effect on efficiency. The modulator was set to a modulation frequency of 25 kHz. A 0.1Ω resistor was used to minimize power loss. A peak duty cycle of 90% was programmed, and occurred at a current pulse of 195 mA. The peak duty cycle circuit was configured to adjust the output voltage to obtain this peak duty cycle. From the series resistance of the LED load, the current amplitude ripple was calculated to be 215 mA, leading to a maximum current pulse amplitude of 410 mA.

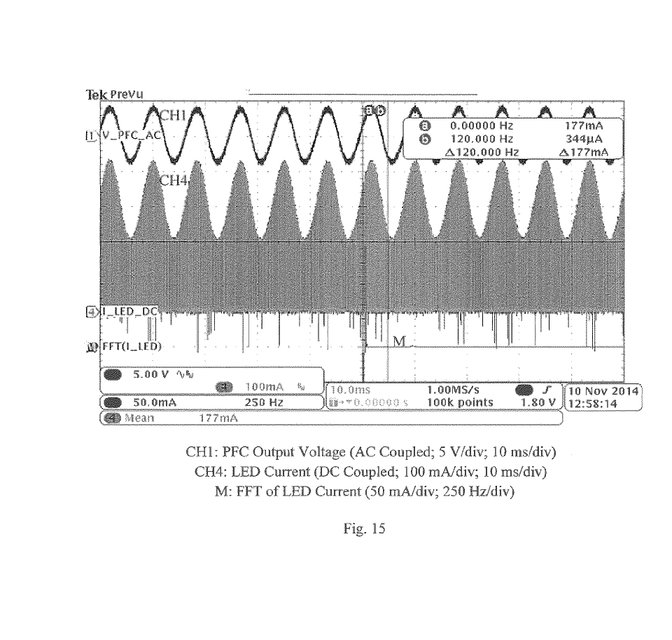

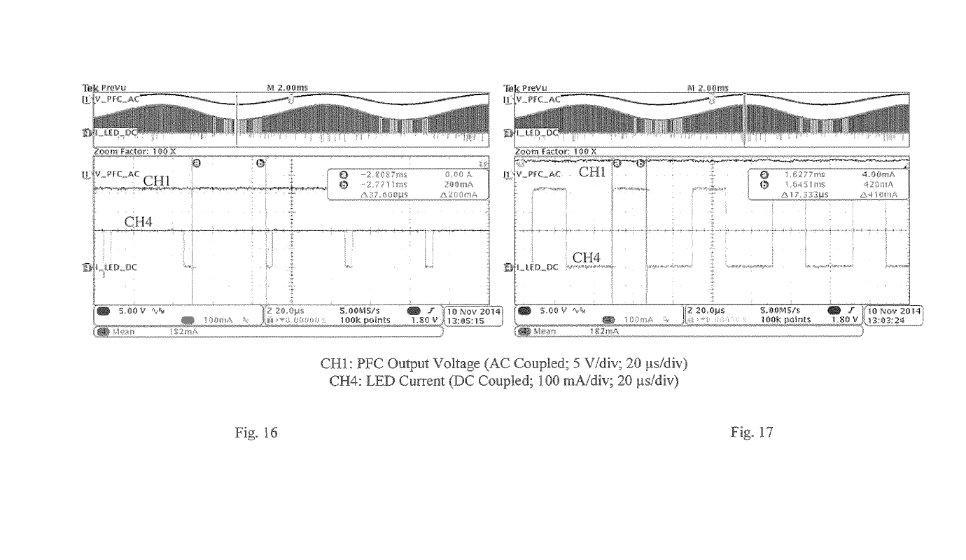

The waveform of the modulated LED current is presented FIG. 15, along with its FFT result. The cursors (a, b) in FIG. 15 correspond to DC and 120 Hz components of the FFT result. It can be seen that there was substantially no 120 Hz component in the LED current. The peak and minimum duty cycles of the LED current are shown in FIGS. 16 and 17, respectively. The minimum current pulse of 200 mA, maximum current pulse of 420 mA, and current amplitude ripple of 220 mA all correspond to their calculated values.

Relative to the conventional buck-boost driver, the driver with the average current modulator reduced the 120 Hz component of the LED current to 344 μAᵣₘₛ, which leads to modulation index of 0.27% (344 μA*1.414/177 mA). Use of the modulator reduced the 120 Hz current ripple from 43% to 0.27%. It is important to note that the amplitude of the LED current pulses will vary at the low (twice line) frequency, but due to the modulation method the LED current contains very little content at this low frequency.

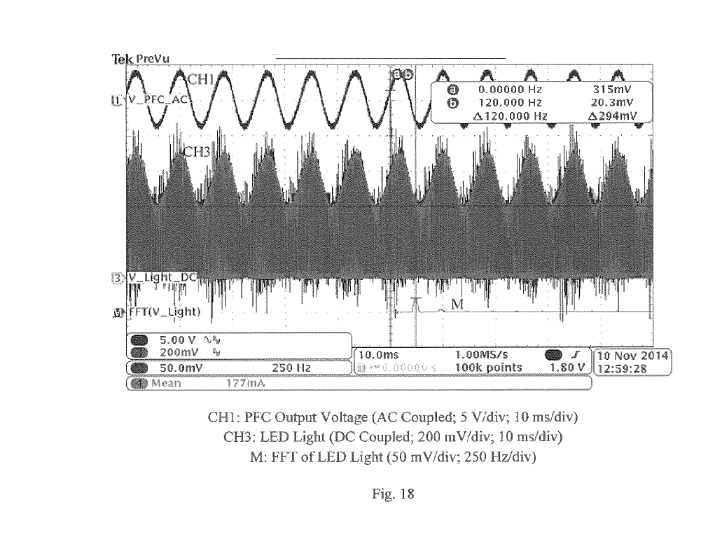

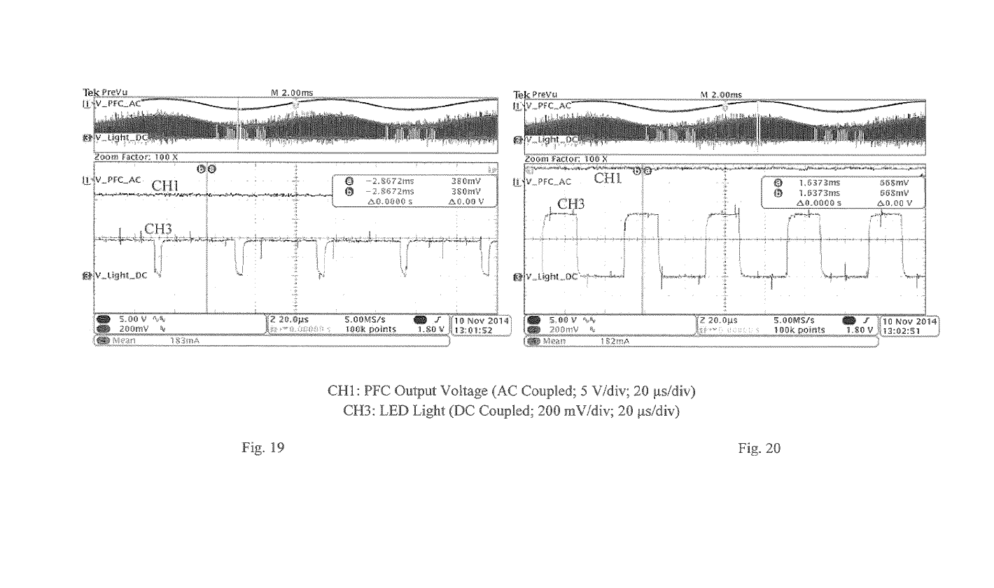

The waveform of the modulated LED light is presented in FIG. 18, along with its FFT result. The LED light modulation is shown in FIGS. 19 and 20, where the peak and minimum duty cycles are shown, respectively. With the average current modulator, the 120 Hz component modulation index of the LED light was calculated as 9.1% (20.3 mV*1.414/315 mV). Thus, relative to the conventional buck-boost driver, the average current modulator reduced the 120 Hz light modulation index from 37.7% to 9.1%. This is below the limit proposed for low risk light flicker at 120 Hz (B. Lehman, et al., “Designing to Mitigate Effects of Flicker in LED Lighting: Reducing Risks to Health and Safety”, Power Electronics Magazine, IEEE, vol. 1, no. 3, pp. 18-26, September 2014).

The measured efficiency of the LED driver with the average current modulator was about 86-88% over the range of input voltage from 90 to 210 Vᵣₘₛ. This was less than a 1% drop in efficiency relative to the conventional buck-boost driver. The data confirm that the average current modulator can be used in low and medium power applications with minimal power loss. The results also showed that there was essentially no difference in measured power factor of the buck-boost LED driver with and without the average current modulator.

The results show that the buck-boost LED driver with the average current modulator limited the low frequency LED current to 344 μAᵣₘₛ using only a 56 μF capacitor. Without the average current modulator, the LED driver would require a 12,770 μF capacitor to limit the low frequency LED current to 344 μAᵣₘₛ, as calculated from (10).

### Example 2. Flyback LED Driver with Average Current Adjustment

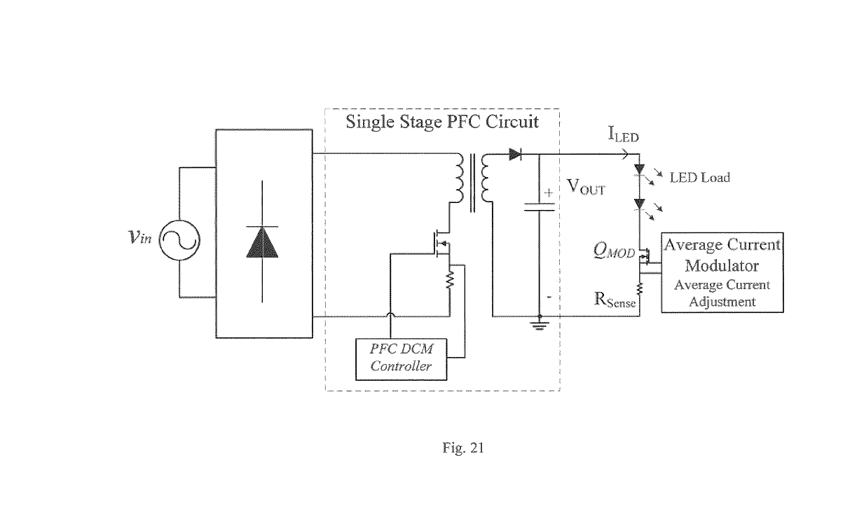

An isolated flyback LED driver was built and tested to demonstrate the operation of the average current modulator with average current adjustment for peak duty cycle control. The circuit is shown in FIG. 21. The output was designed to operate at ˜50 V/500 mA for 25 W of power from a 60 Hz AC power supply. The load was 20 LED chips (OSRAM Golden Dragon Plus LUW-W5AM). Rated for a maximum current of 1 A, the LEDs exhibit a forward voltage of 2.1 V and a series resistance of 0.67Ω at 500 mA. The resistance of the LED load was 13.4Ω.

A 10 nF capacitor was connected across the LED load to prevent voltage spikes caused by the modulation method. The voltage across this small capacitor is not discharged by the modulation method and therefore it had no effect on efficiency. The modulator was set to a modulation frequency of 25 kHz. The components used to configure the modulator were the same as in Example 1, listed in Table 2. A peak duty cycle of 90% was programmed, which occurred at a current pulse of 555 mA. From the series resistance of the LED load, the current amplitude ripple was calculated to be 447 mA, leading to an estimated peak current pulse of approximately 1 A.

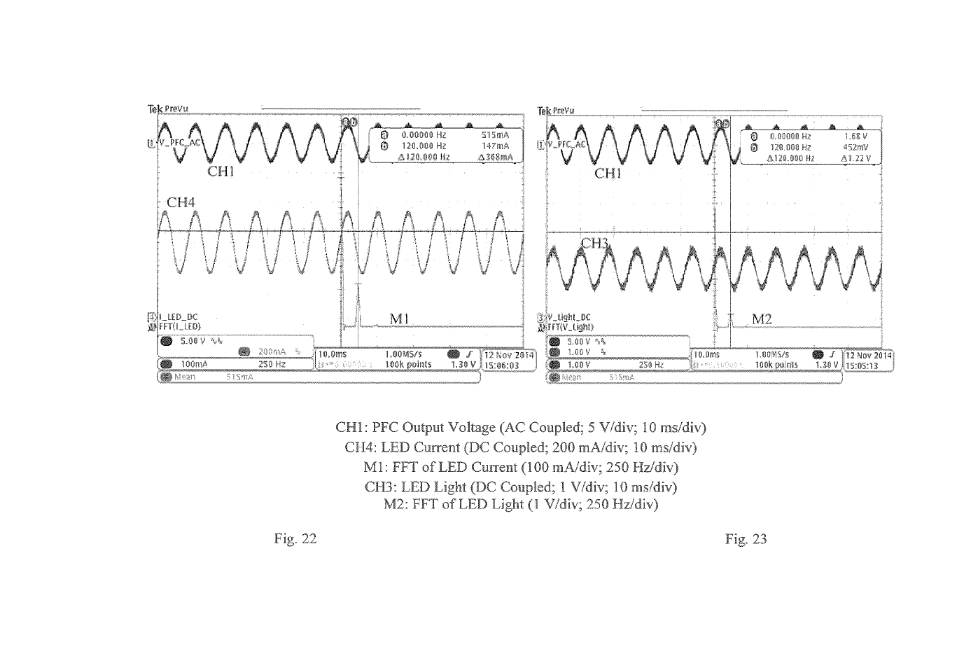

A conventional single stage PFC flyback LED driver was built and tested to provide a reference to measure the performance of the average current modulator design. The flyback PFC circuit was implemented with a FL7732 Primary Side Regulated PFC Controller (Fairchild). The LED light was sensed by a light to voltage sensor as described in Example 1. The waveforms of LED current and light are presented in FIGS. 22 and 23, respectively. The FFT results of these waveforms provide a metric to compare the attenuation of low frequency current and light ripple of the LED load between the two power supplies. The energy storage capacitance was calculated to be 198 μF. Three 68 μF capacitors were used for a total of 204 μF.

As shown in FIG. 22, the conventional flyback LED driver load current had a 120 Hz ripple of 147 mAᵣₘₛ with a DC current of 515 mA, or a modulation index of 40% (147 mA*1.414/515 mA). The modulation index of the LED light (FIG. 23) was 38% (452 mV*1.414/1.68 V).

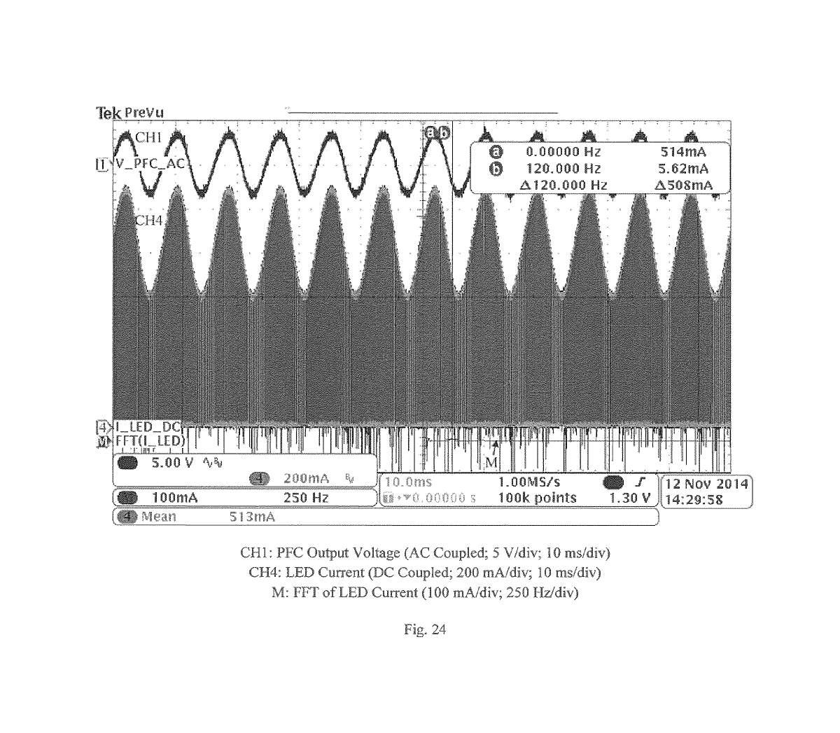

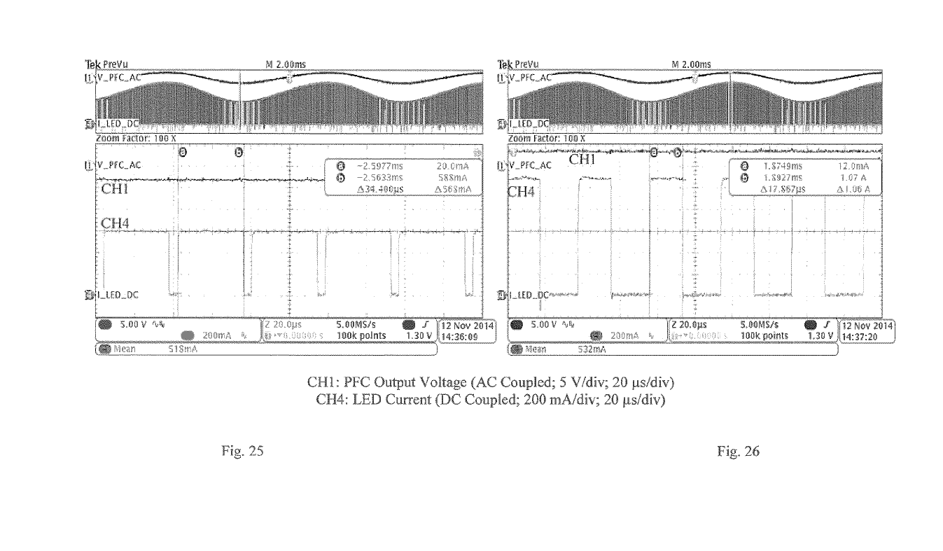

For the average current modulator LED driver, the waveform of the modulated LED current is shown FIG. 24, along with its FFT result. The cursors (a, b) in FIG. 24 correspond to DC and 120 Hz components of the FFT result. It can be seen that there was substantially no 120 Hz component in the LED current. The peak and minimum duty cycles of the LED current are shown in FIGS. 25 and 26, respectively. The minimum current pulse of 588 mA, maximum current pulse of 1.07 A, and current amplitude ripple of 482 mA all correspond to their calculated values.

Relative to the conventional flyback LED driver, the results show that the average current modulator reduced the 120 Hz component of the LED current to 5.62 mAᵣₘₛ, with a current modulation index of 1.54% (5.62 mA*1.414/514 mA). Thus, use of the average current modulator reduced the 120 Hz current modulation index from 40% to 1.54%. It is important to note that the amplitude of the LED current pulses will vary at the low (twice line) frequency, but due to the modulation method the LED current contains very little content at this low frequency.

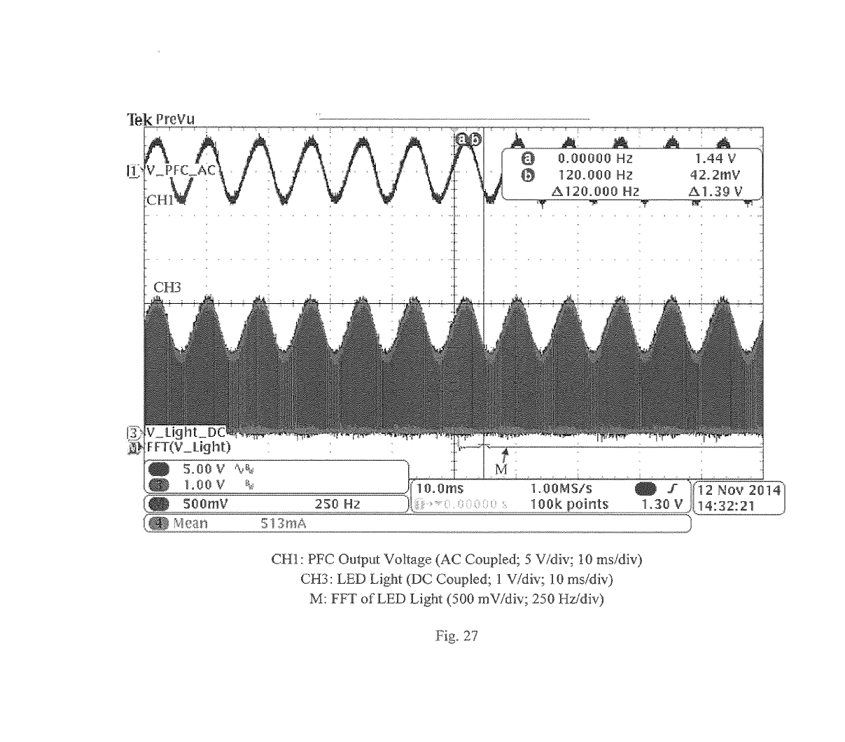

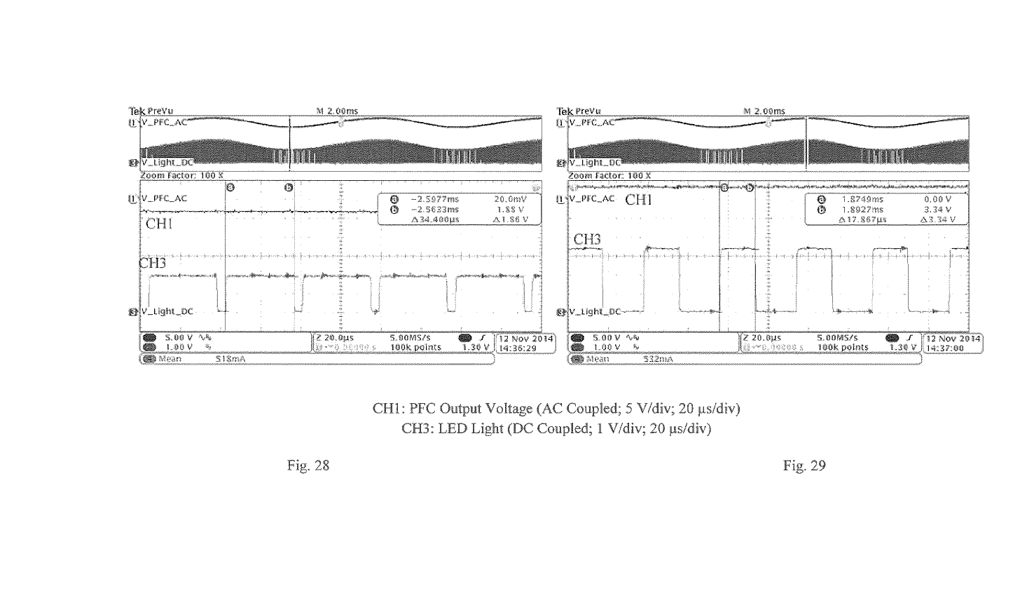

The waveform of the modulated LED light is presented in FIG. 27, along with its FFT result. The LED light modulation is shown in FIGS. 28 and 29, where the peak and minimum duty cycles are shown, respectively. The 120 Hz component of the LED light modulation index was calculated to be 4.1% (42.2 mV*1.414/1.44 V). Use of the average current modulator reduced the 120 Hz light modulation index from 38% to 4.1%. As in Example 1, this is well below the limit discussed in B. Lehman, et al. (2014) for low risk light flicker at 120 Hz.

The measured efficiency of the LED driver with the average current modulator was about 84-86% over the range of input voltage from 90 to 210 Vᵣₘₛ. This was less than a 1% drop in efficiency relative to the conventional flyback driver. The data confirm that the average current modulator can be used in low and medium power applications with minimal power loss. The results also showed that high power factor (>0.9) was achieved for input voltage from 90 to 210 Vᵣₘₛ, and there was essentially no difference in measured power factor of the flyback LED driver with and without the average current modulator.

The flyback LED driver with the average current modulator limited the low frequency LED current to 5.62 mAᵣₘₛ using only a 204 μF capacitor. Without the average current modulator, the LED driver would require a 6,410 μF capacitor to limit the low frequency LED current to 5.62 mAᵣₘₛ, as calculated from (10).

All cited publications are incorporated herein by reference.

### EQUIVALENTS

Those skilled in the art will recognize or be able to ascertain variants of the embodiments described herein. Such variants are within the scope of the invention and are covered by the appended claims.

1. An AC-DC converter, comprising:
a power factor correction (PFC) stage that receives AC power and outputs DC load current, the DC load current comprising a low-frequency AC ripple component;
a series-connected switch and current sensing resistor, the series-connected switch and current sensing resistor connected in series with the load;
an average current controller that samples the load current and controls a duty cycle of the switch so that the average load current is maintained at a selected current by comparing to a current control signal;
wherein the low-frequency AC ripple component of the load current is reduced or eliminated.

2. The AC-DC converter of claim 1, wherein the average current controller controls the duty cycle of the switch at a high modulation frequency.

3. The AC-DC converter of claim 2, wherein the high modulation frequency is between 20 kHz and 25 kHz.

4. The AC-DC converter of claim 1, wherein the current control signal is a programmed reference value.

5. The AC-DC converter of claim 1, wherein the average current controller comprises an integrator and a sample and hold circuit to sample the load current.

6. The AC-DC converter of claim 1, wherein the average current controller comprises an integrator and a low pass filter to sample the load current.

7. The AC-DC converter of claim 4, comprising:
a peak duty cycle controller that generates an error signal by comparing a detected peak duty cycle to a programmed peak duty cycle of the switch;
wherein the error signal adjusts average output voltage of the PFC stage such that the peak duty cycle of the switch is equal to the programmed peak duty cycle.

8. The AC-DC converter of claim 7, wherein the peak duty cycle controller includes a sample and hold circuit.

9. The AC-DC converter of claim 7, wherein the peak duty cycle controller includes a forward, low impedance current path and a reverse, high impedance current path.

10. The AC-DC converter of claim 1, comprising:
a peak duty cycle controller that generates an error signal by comparing a detected peak duty cycle to a programmed peak duty cycle of the switch;
wherein the current control signal is set according to the error signal.

11. The AC-DC converter of claim 10, wherein the peak duty cycle controller includes a sample and hold circuit.

12. The AC-DC converter of claim 10, wherein the peak duty cycle controller includes a forward, low impedance current path and a reverse, high impedance current path.

13. The AC-DC converter of claim 1, further comprising a load current limiting loop that limits the load current by adjusting a gate drive voltage of the switch.

14. A method for reducing or eliminating a low-frequency AC ripple component of a load current of a single-stage PFC AC-DC converter, comprising:
sampling the load current and comparing the sampled load current to a current control signal corresponding to a selected current;
controlling a duty cycle of a switch connected in series with the load so that an average load current is maintained at the selected current;
wherein the low-frequency AC ripple component of the load current is reduced or eliminated.

15. The method of claim 14, comprising controlling the duty cycle of the switch at a high modulation frequency.

16. The method of claim 14, wherein the high modulation frequency is between 20 kHz and 25 kHz.

17. The method of claim 14, wherein the current control signal is a programmed reference value.

18. The method of claim 14, wherein sampling the load current comprises using an integrator and a sample and hold circuit.

19. The method of claim 14, wherein sampling the load current comprises using an integrator and a low pass filter.

20. The method of claim 17, comprising:
detecting a peak duty cycle of the switch;
generating an error signal by comparing the detected peak duty cycle of the switch to a programmed peak duty cycle; and
using the error signal to adjust average output voltage of the PFC stage such that the peak duty cycle of the switch is equal to the programmed peak duty cycle.

21. The method of claim 20, wherein detecting a peak duty cycle of the switch comprises using a sample and hold circuit.

22. The method of claim 20, wherein detecting a peak duty cycle of the switch comprises using a forward, low impedance current path and a reverse, high impedance current path.

23. The method of claim 14, comprising:
detecting a peak duty cycle of the switch;
generating an error signal by comparing the detected peak duty cycle of the switch to a programmed peak duty cycle; and
setting the current control signal according to the error signal.

24. The method of claim 23, wherein detecting a peak duty cycle of the switch comprises using a sample and hold circuit.

25. The method of claim 23, wherein detecting a peak duty cycle of the switch comprises using a forward, low impedance current path and a reverse, high impedance current path.

26. The method of claim 14, further comprising limiting the load current by adjusting a gate drive voltage of the switch.

27. A circuit for use with an AC-DC converter, comprising:
a series-connected switch and current sensing resistor, the series-connected switch and current sensing resistor adapted for connection in series with a load of the AC-DC converter;
an average current controller that samples a load current and controls a duty cycle of the switch so that an average load current is maintained at a selected current by comparing to a current control signal;
wherein a low-frequency AC ripple component of the load current is reduced or eliminated.

28. The circuit of claim 27, comprising:
a peak duty cycle controller that generates an error signal by comparing a detected peak duty cycle to a programmed peak duty cycle of the switch;
wherein the error signal is used to control the duty cycle of the switch.
